(19) United States
(12) Patent Application Publication
(10) Pub. No.: US 2026/0010370 A1
(43) Pub. Date: Jan. 8, 2026

(54) TOOL FOR SITUATION DETERMINATION AND CHANGE PREDICTION, AND METHOD AND SYSTEM FOR PROVIDING SERVICE THEREOF

(71) Applicant: Seong Dae YIM, Daegu (KR)

(72) Inventor: Seong Dae YIM, Daegu (KR)

(21) Appl. No.: 19/118,277

(22) PCT Filed: Oct. 15, 2024
(86) PCT No.: PCT/KR2024/015584

§ 371 Date: Apr. 3, 2025

(30) Foreign Application Priority Data
Jun. 4, 2024 (KR) 10-2024-0073092
Jun. 4, 2024 (KR) 10-2024-0073093
Aug. 17, 2024 (KR) 10-2024-0110140

(51) Int. Cl. G06F 9/30; G06F 3/01

(52) U.S. Cl. CPC G06F 9/30018; G06F 3/011

(57) ABSTRACT

The present invention implements a tool for situation determination and change prediction based on a principle of change in a binary format considering time, thereby helping people accurately determine situations occurring to themselves and their surroundings and predict the situations in the future by enabling the people to predict the situations, providing a service in cooperation with a server, artificial intelligence, and a database through an online service, and receiving a service of a service unit based on a situation category arrangement table in the tool for situation determination and change prediction.

### TECHNICAL FIELD

The present invention relates to a tool for determining situations and predicting changes, and more specifically, to a tool, and a method and a system for providing services thereof, in which the tool uses a principle of change in a binary format to help people accurately determine situations occurring to themselves and their surroundings and predict the situations in the future by enabling the people to predict the situations.

### BACKGROUND ART

These days, as the living environment improves, many people are using convenient and diverse electronic devices, and as people see and hear more things, they want help in making the right decisions in their various situations.

In that case, people find content related to proverbs and wisdom in books and YouTube videos. However, these books and videos have the advantage of presenting good methods, but they have the disadvantage of being generalized rather than personalized.

In other words, it is difficult to have the ability to make accurate determination in specific situations occurring to individuals and predict changing situations in advance, or to provide customized help in such situations.

Therefore, if a tool that may accurately determine specific situations occurring to individuals and predict changing situations in advance or a service using the tool is implemented, it will receive great response from many people involved.

### DISCLOSURE

### Technical Problem

Accordingly, an object of the present invention is to provide a tool for determining situations and predicting changes by using a principle of change in a binary format considering time, and a method and a system for providing a service thereof.

Another object of the present invention is to provide a tool for situation determination and change prediction, and a method and a system for providing a service thereof, in which the tool is provided together with artificial intelligence to help people accurately determine situations occurring to themselves and their surroundings and predict future situation changes

### Technical Solution

To achieve the above object, the present invention provides a tool for situation determination and change prediction, which includes 0 and 1 for expressing occurrence and change of situations in a binary format; a step for sequentially selecting one of 0 and 1 to combine the same; 2^{N} movements (N is a natural number of 2 or more) generated by combining the step N times and vertically arranging the step in chronological order; and 2^{2N} categories (N is a natural number of 2 or more) generated by arranging the 2^{N} movements (N is a natural number of 2 or more) one by one at upper and lower sides in correspondence with each other, in which the 2^{2N} categories (N is a natural number of 2 or more) classify and define situations that occur according to correspondence of upper movement and lower movement, and 2N steps constituting each category classify and define the detailed situations within the category, and in which the tool includes a situation category arrangement table in which 2^{2N} categories (N is a natural number of 2 or more) are sequentially arranged with corresponding numbers in order to represent that the situations are sequentially progressed according to a sequence of category numbers, and represent that the detailed situations are progressed according to a sequence of vertical arrangement of the steps belonging to each category.

In addition, according to another aspect of the present invention, a tool for situation determination and change prediction includes: 0 and 1 for expressing occurrence and change of situations in a binary format; a step for sequentially selecting one of 0 and 1 to combine the same; 8 movements generated by combining the step 3 times and vertically arranging the step in chronological order; and 64 categories generated by arranging the 8 movements one by one at upper and lower sides in correspondence with each other, in which the 64 categories classify and define situations that occur according to correspondence of an upper movement and a lower movement, and 6 steps constituting each category classify and define the detailed situations within the category, and in which the tool includes a situation category arrangement table in which 64 categories are sequentially arranged with corresponding numbers in order to represent that the situations are sequentially progressed according to a sequence of category numbers, and represent that the detailed situations are progressed according to a sequence of vertical arrangement of the steps belonging to each category.

In addition, as another aspect of the present invention, in the tool for situation determination and change prediction, a detailed situation progress list for each category may be provided so as to create the situation category arrangement table, and the detailed situation progress list for each category may be configured by arranging 2N steps, which belong to each category, in multi-layers from a first step at a bottom to a 2Nth step at a top according to a progress sequence of the detailed situation, and arranging an interpretation text representing a meaning of a corresponding step in the step of each layer, and in which a sequential procedure may be repeated in which as the situation is sequentially changed, 0 and 1 of an adjacent upper step of an arbitrary step in a corresponding category are toggled so that the step is progressed to an up-toggle step and the corresponding category is changed into another category, and as the situation of an event is sequentially changed, an adjacent upper basic step is formed due to a change in a level-toggle, in which 0 and 1 of the up-toggle step are toggled, thereby returning to the corresponding category.

In addition, as another aspect of the present invention, the detailed situation progress list for each category may further include a non-sequential procedure development portion in which as the situation is non-sequentially changed in a state where the category is changed into another category due to progress to the up-toggle step, 0 and 1 of the adjacent upper step of the up-toggle step are toggled to form a second up-toggle step, thereby changing into still another category.

In addition, as another aspect of the present invention, a method for providing a situation determination and change prediction service includes: providing 0 and 1 for expressing occurrence and change of situations in a binary format; providing a step for sequentially selecting one of 0 and 1 to combine the same; providing 2^{N} movements (N is a natural number of 2 or more) generated by combining the step N times and vertically arranging the step in chronological order; and providing 2^{2N} categories (N is a natural number of 2 or more) generated by arranging the 2^{N} movements (N is a natural number of 2 or more) one by one at upper and lower sides in correspondence with each other, in which the 2^{2N} categories (N is a natural number of 2 or more) classify and define situations that occur according to correspondence of upper movement and lower movement, and 2N steps constituting each category classify and define the detailed situations within the category, and in which the method includes: a process of registering and updating a situation category arrangement table in a database of a server, in which the situation category arrangement table has the 2^{2N} categories (N is a natural number of 2 or more) that are sequentially arranged with corresponding numbers in order to represent that the situations are sequentially progressed according to a sequence of category numbers, and represent that the detailed situations are progressed according to a sequence of vertical arrangement of the steps belonging to each category; a process of confirming a user request received from a user terminal through a network, by the server; a process of performing a situation determination and change prediction service based on the situation category arrangement table in response to the user request and generating a service processing result, by the server; and a process of providing the generated processing result to the user terminal requesting the service through the network.

In addition, as another aspect of the present invention, a method for providing a situation determination and change prediction service includes: 0 and 1 for expressing occurrence and change of situations in a binary format; a step for sequentially selecting one of 0 and 1 to combine the same; 2^{N} movements (N is a natural number of 2 or more) generated by combining the step N times and vertically arranging the step in chronological order; and 2^{2N} categories (N is a natural number of 2 or more) generated by arranging the 2^{N} movements (N is a natural number of 2 or more) one by one at upper and lower sides in correspondence with each other, in which the 2^{2N} categories (N is a natural number of 2 or more) classify and define situations that occur according to correspondence of upper movement and lower movement, and 2N steps constituting each category classify and define the detailed situations within the category, and in which the method includes: a process of providing a situation category arrangement table in at least one service unit of an experience center, a school, a conference hall, and a content production studio for situation determination and change prediction in a metaverse platform, in which the situation category arrangement table has the 2^{2N} categories (N is a natural number of 2 or more) that are sequentially arranged with corresponding numbers in order to represent that the situations are sequentially progressed according to a sequence of category numbers, and represent that the detailed situations are progressed according to a sequence of vertical arrangement of the steps belonging to each category; and a process of receiving a service of the service unit based on the situation category arrangement table, by a user who visits the metaverse platform.

In addition, as another aspect of the present invention, a method for providing a situation determination and change prediction service includes: 0 and 1 for expressing occurrence and change of situations in a binary format; a step for sequentially selecting one of 0 and 1 to combine the same; 2^{N} movements (N is a natural number of 2 or more) generated by combining the step N times and vertically arranging the step in chronological order; and 2^{2N} categories (N is a natural number of 2 or more) generated by arranging the 2^{N} movements (N is a natural number of 2 or more) one by one at upper and lower sides in correspondence with each other, in which the 2^{2N} categories (N is a natural number of 2 or more) classify and define situations that occur according to correspondence of upper movement and lower movement, and 2N steps constituting each category classify and define the detailed situations within the category, and in which the method includes: a process of installing a situation category arrangement table as an independent service type without supporting a dedicated service on a terminal that creates an extended reality (XR) environment, in which the situation category arrangement table has the 2^{2N} categories (N is a natural number of 2 or more) are sequentially arranged in order with corresponding numbers in order to represent that the situations are sequentially progressed according to a sequence of category numbers, and represent that the detailed situations are progressed according to a sequence of vertical arrangement of the steps belonging to each category; and a process of receiving a service of a terminal service unit based on the situation category arrangement table, by a user who enters the extended reality (XR) environment created using the terminal.

In addition, as another aspect of the present invention, a system for providing a situation determination and change prediction service using a principle of change in a binary format include: 0 and 1 for expressing occurrence and change of situations in a binary format; a step for sequentially selecting one of 0 and 1 to combine the same; 2^{N} movements (N is a natural number of 2 or more) generated by combining the step N times and vertically arranging the step in chronological order; and 2^{2N} categories (N is a natural number of 2 or more) generated by arranging the 2^{N} movements (N is a natural number of 2 or more) one by one at upper and lower sides in correspondence with each other, in which 2^{2N} categories (N is a natural number of 2 or more) classify and define situations that occur according to correspondence of upper movement and lower movement, and 2N steps constituting each category classify and define the detailed situations within the category, and in which the system includes: a database for storing a situation category arrangement table, in which the 2^{2N} categories (N is a natural number of 2 or more) are sequentially arranged with corresponding numbers in order to represent that the situations are sequentially progressed according to a sequence of category numbers, and represent that the detailed situations are progressed according to a sequence of vertical arrangement of the steps belonging to each category; an artificial intelligence inference unit configured to infer a user request by artificial intelligence in relation to the situation determination and change prediction service using the situation category arrangement table of the database; and a server configured to confirm the user request received from a user terminal through a network, to perform the situation determination and change prediction service based on information in the situation category arrangement table of the database and inference of the artificial intelligence inference unit, and to generate a service processing result, thereby providing the service processing result to the user terminal.

In addition, as another aspect of the present invention, a system for providing a situation determination and change prediction service includes: 0 and 1 for expressing occurrence and change of situations in a binary format; a step for sequentially selecting one of 0 and 1 to combine the same; 2^{N} movements (N is a natural number of 2 or more) generated by combining the step N times and vertically arranging the step in chronological order; and 2^{2N} categories (N is a natural number of 2 or more) generated by arranging the 2^{N} movements (N is a natural number of 2 or more) one by one at upper and lower sides in correspondence with each other, in which the 2^{2N} categories (N is a natural number of 2 or more) classify and define situations that occur according to correspondence of upper movement and lower movement, and 2N steps constituting each category classify and define the detailed situations within the category, and in which the system includes: a dedicated metaverse platform in which a situation category arrangement table is implemented in a service unit of each location in a metaverse, in which the situation category arrangement table has the 2^{2N} categories (N is a natural number of 2 or more) that are sequentially arranged with corresponding numbers in order to represent that the situations are sequentially progressed according to a sequence of category numbers, and represent that the detailed situations are progressed according to a sequence of vertical arrangement of the steps belonging to each category; and a terminal connection unit configured to allow a user or a user avatar who visits the metaverse platform for situation determination and change prediction to receive a service of the service unit based on the situation category arrangement table.

### Advantageous Effects

As described above, the present invention implements a tool for determining a situation and predicting changes by using a principle of change in a binary format considering time, and a method and a system for providing a service thereof, so that it is possible to accurately determine a specific situation occurring to an individual and predicting in advance situation changes in the future.

### DESCRIPTION OF DRAWINGS

FIG. 1 is a diagram for explaining “0” and “1” in a binary format, which are used in a tool for situation determination and change prediction, according to an embodiment of the present invention.

FIG. 2 is an exemplary configuration diagram for showing a relationship between “step” and “movement” used in the tool for situation determination and change prediction when N=3 according to the embodiment of the present invention.

FIG. 3 is an exemplary configuration diagram implementing “movement” when N=3 according to the embodiment of the present invention.

FIG. 4 is an exemplary configuration diagram related to “category” when N=3 according to the embodiment of the present invention.

FIG. 5 is a diagram showing a process of generating components used in the tool for situation determination and change prediction according to the embodiment of the present invention.

FIG. 6 is a diagram showing a process of generating components used in the tool for situation determination and change prediction when N=3 according to the embodiment of the present invention.

FIG. 7 is a diagram for showing symbols and a sequence of numbers of 64 “categories” generated by arranging 8 movements one by one at upper and lower sides in correspondence with each other when N=3, according to the embodiment of the present invention.

FIGS. 8 to 11 are diagrams for showing the meaning of the symbols of 64 “categories” generated by arranging 8 upper movements and 8 lower movements at upper and lower sides in correspondence with each other when N=3, according to the embodiment of the present invention.

FIG. 12 is a diagram for showing a situation category arrangement table used in the tool for situation determination and change prediction when N=3 according to the embodiment of the present invention.

FIG. 13 is a detailed situation progress list showing a sequential process in a 1st category among 64 categories when N=3 according to the embodiment of the present invention.

FIG. 14 is a detailed situation progress list showing a sequential process in a 2nd category among 64 categories when N=3 according to the embodiment of the present invention.

FIG. 15 is a detailed situation progress list showing a non-sequential procedure development portion and the sequential process of the 1st category among 64 categories when N=3 according to the embodiment of the present invention.

FIG. 16 is a detailed situation progress list showing a non-sequential procedure development portion and the sequential process of the 2nd category among 64 categories when N=3 according to the embodiment of the present invention.

FIG. 17 is a case exemplary diagram in which the detailed situation progress list for situation determination and change prediction is applied to a true story-based movie when N=3 according to the embodiment of the present invention.

FIG. 18 is an exemplary diagram showing that the same detailed situation in the detailed situation progress list for situation determination and change prediction is reproduced by various cases when N=3 according to the embodiment of the present invention.

FIG. 19 is a configuration diagram of an online service system for situation determination and change prediction according to the embodiment of the present invention.

FIG. 20 is a detailed block configuration diagram related to an artificial intelligence inference unit, an artificial intelligence ethics inspection unit, and a database block.

FIG. 21 is a configuration diagram of detailed blocks of the database block shown in FIGS. 19 and 20.

FIG. 22 is a schematic control flowchart of providing a situation determination and change prediction service according to the embodiment of the present invention.

FIG. 23 is a schematic control flowchart of a user-provided information analysis service according to the embodiment of the present invention.

FIG. 24 is a configuration diagram of a service system for situation determination and change prediction in a metaverse environment according to the embodiment of the present invention.

FIG. 25 is an exemplary block diagram of an independent service terminal for situation determination and change prediction according to the embodiment of the present invention.

### MODE FOR INVENTION

The terms or words used throughout the present specification and claims should not be limitedly interpreted based on the typical meaning or the meaning of the dictionary but should be interpreted as the meaning and concept which may well match with the technical concept of the present invention based on the principle where the inventor himself/herself may properly define the concepts of the terms so as to describe his/her invention in the best way.

In addition, since the embodiments described in the present specification and the configurations shown in the drawings are merely the most preferred embodiments of the present invention and do not represent all of the technical ideas of the present invention, it should be understood that there may be modified examples corresponding to various equivalents capable of replacing them at the time of filing the present application, and a detailed description of unnecessary components will be omitted in order to describe the gist of the present invention.

Hereinafter the preferred embodiments of the present invention will be described with reference to the accompanying drawings.

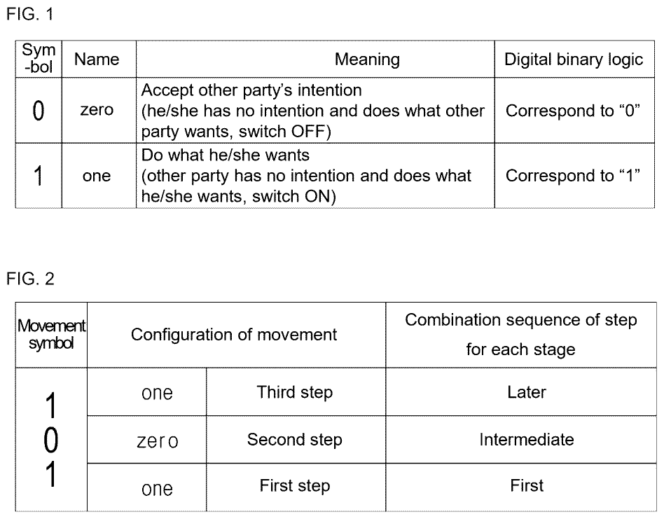

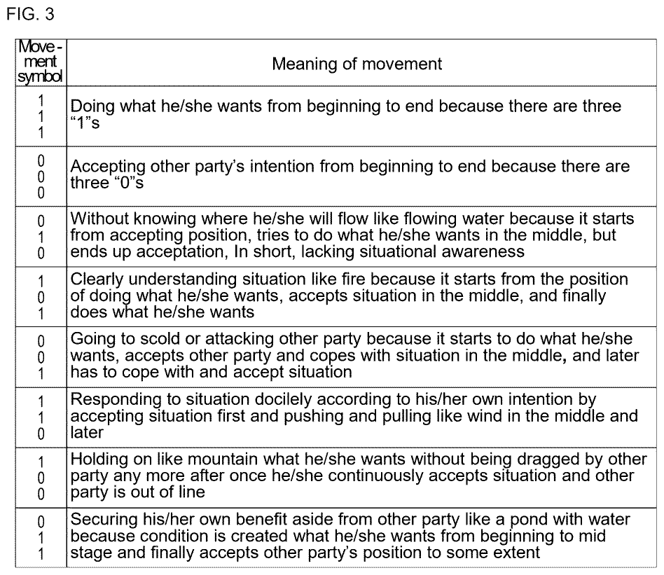

FIG. 1 is a diagram for explaining “0” and “1” in a binary format, which are used in a tool for situation determination and change prediction, according to an embodiment of the present invention, FIG. 2 is an exemplary configuration diagram for showing a relationship between ‘step’ and ‘movement’ used in the tool for situation determination and change prediction when N=3 according to the embodiment of the present invention, and FIG. 3 is an exemplary configuration diagram implementing ‘movement’ when N=3 according to the embodiment of the present invention.

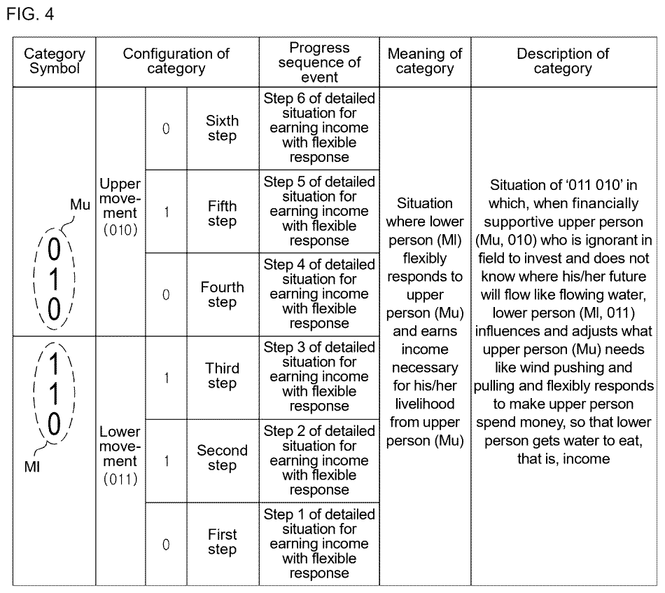

In addition, FIG. 4 is an exemplary configuration diagram related to “category” when N=3 according to the embodiment of the present invention.

In the present invention, the tool for determining situations and predicting changes is implemented using a principle of change in a binary format considering time.

The tool for determining a situation and predicting changes according to the present invention includes “0” and “1”, “step”, “movement”, and “category” as components.

FIG. 1 shows definitions and meanings related to “0 and 1” among components of the tool for situation determination and change prediction according to an embodiment of the present invention.

In the configuration of the present invention, “0 and 1” are symbols for expressing the occurrence and change of a situation in a binary format, in which “0” is defined as a meaning of accepting the other party's intention. That is, “0” means that he/she has no intention and does what the other party wants (switch OFF).

In addition, “1” is defined as a meaning of doing what he/she wants. That is, “1” means that the other party has no intention, but only he/she has an intention, so he/she does what he/she wants (switch ON).

The configurations “0 and 1” of the present invention may correspond to “0 (logic low)” and “1 (logic high)” in digital binary logic.

FIG. 2 shows an example of a definition and configuration relationship in relation to “step” and “movement” among components of the tool for situation determination and change prediction according to the embodiment of the present invention, in which N is 3 (N is a natural number of 2 or more).

The “step” among the configurations of the present invention is defined as an element for combining in chronological order by selecting one of “0” and “1”, which are symbol means for expressing prediction of the occurrence and change of a situation in a binary format

The “step” may be combined N times (N is a natural number of 2 or more) in chronological order, and a result of combining the step N times (N is a natural number of 2 or more) in chronological order is defined as “movement”.

That is, in the present invention, the “movement” is defined as 2^{N} activities (N is a natural number of 2 or more) generated as a result of combining the step N times from a first step at the bottom to an Nth step at the top in chronological order

In FIG. 2, a case of N=3 is shown as “1 0 1”, in which the bottom is the first step “1”, the middle is a second step “0”, the top is a third step “1”, and the arrangement from the bottom to the top is in chronological order.

Each of movements expressed as 2^{N} (N is a natural number of 2 or more) is expressed by activity characteristics that may occur randomly in the world.

Each of 2^{N} movements (N is a natural number of 2 or more) has a different meaning, and the meaning of each movement is determined according to a configuration ratio of “0” and “1” and the arrangement sequence of “0” and “1”.

That is, the characteristics of the movement depend on the configuration ratio and arrangement of “0” and “1” constituting the symbol of each movement.

FIG. 3 shows an example of implementation of “movement” according to the embodiment of the present invention, and is the case of N=3.

Referring to FIG. 3, the “movement” when N=3 shows that 23 movements, that is, 8 movements are generated. That is, 8 movements are expressed as “1 (bottom) 1 (middle) 1 (top), 000, 010, 101, 001, 110, 100, 011”.

In FIG. 3, since N=3, each “movement” has three steps. That is, each “movement” has a first step, a second step, and a third step.

In addition, FIG. 3 shows an example of how the meaning of “movement” is changed according to the configuration ratio of “0” and “1” and the arrangement sequence of “0” and “1”.

Referring to FIG. 3, the movement “111” means to do what he/she wants from the beginning to the end because there are three “1”s, and the movement “000” means that the other party's intention is accepted from the beginning to the end because there are three “0”s.

In addition, the movement “101, 110, 011” is a case where there are two “1”s and one “0”, in which “1” as doing what he/she wants is greater than “0” accepting the other party. Therefore, the active meaning is certainly strong as shown in FIG. 3.

Further, the movement “010, 001, 100” is a case where there are one “1” and two “0”s, in which “0” accepting the other party is greater than “1” as doing what he/she wants. Therefore, the passive meaning is strong as shown in FIG. 3.

FIG. 4 is an exemplary configuration diagram related to “category” among components according to the embodiment of the present invention, and it shows a configuration example of the “category” according to the case of N=3.

In the components of the present invention, the “category” is defined as the arrangement in which the “movements” are arranged one by one at upper and lower sides in correspondence with each other.

According to the present invention, 2^{2N} categories (N is a natural number of 2 or more) are provided by arranging the 2^{N} movements (N is a natural number of 2 or more) one by one at the upper and lower sides in correspondence with each other. That is, 2^{2N} categories (N is a natural number of 2 or more) are generated and expressed.

In the “upper movement Mu” and the “lower movement MI” constituting one category, the “upper movement Mu” means movement characteristics of a superior (strong person). The “lower movement MI” means movement characteristics of an inferior (weak person).

Therefore, the “category” is expressed as 2^{2N} situations that may occur due to the correspondence between 2^{N} upper movements (N is a natural number of 2 or more) (superior or strong person) and 2^{N} lower movements (N is a natural number of 2 or more) (inferior or weak person).

For example, as shown in FIG. 4, when N=3, the “category” is expressed as 64 [2^{2N}(N=3)] situations that may occur between 8 [2^{N}(N=3)] upper movements Mu (superior or strong person) and 8 [2^{N}(N=3)] lower movements MI (inferior or weak person).

The meaning of each category depends on the characteristics of the upper movement Mu constituting the corresponding category and the characteristics of the lower movement MI corresponding thereto, and it may be confirmed by a category code CC of each category.

In this case, the reason why 8 upper movements Mu (superior or strong person) and 8 lower movements MI (inferior or weak person) are arranged at upper and lower sides in correspondence with each other to generate 64 categories is as follows.

The reason is to preferably represent situations that occur and change due to power differences in the relationship between superiors and inferiors, or between the strong and the weak

Each category consists of an upper movement Mu, in which the steps are combined in N steps in chronological order, and the lower movement MI, in which the steps are combined in N steps in chronological order, correspond to each other at the upper and lower sides, and includes a total of 2N steps.

As shown in the example of FIG. 4, when N=3, each category consists of the upper movement Mu, in which the steps are combined in 3 steps in chronological order, and the lower movement MI, in which the steps are combined in 3 steps in chronological order, correspond to each other at upper and lower sides, and includes a total of 6 steps.

Thus, 6 steps belonging to one category are 6 detailed situations belonging to the corresponding category.

The 6 steps include steps first, second, and third of the corresponding category configured by the lower movement MI, and steps fourth, fifth, and sixth configured by the upper movement Mu.

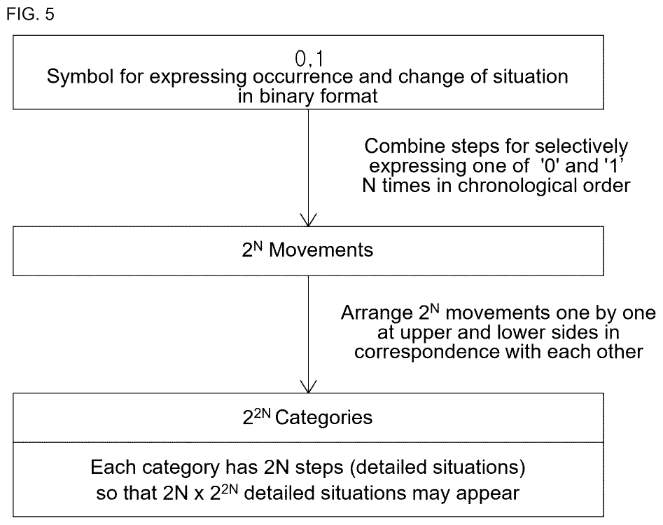

FIG. 5 is a diagram for explaining a process of generating 2^{N} “movements” and 2^{2N} “categories” by using “0” and “1” used in the tool for situation determination and change prediction according to the embodiment of the present invention, and shows a summary of the descriptions related to “0”, “1”, “movement”, and “category” described above with reference to FIGS. 1 to 4.

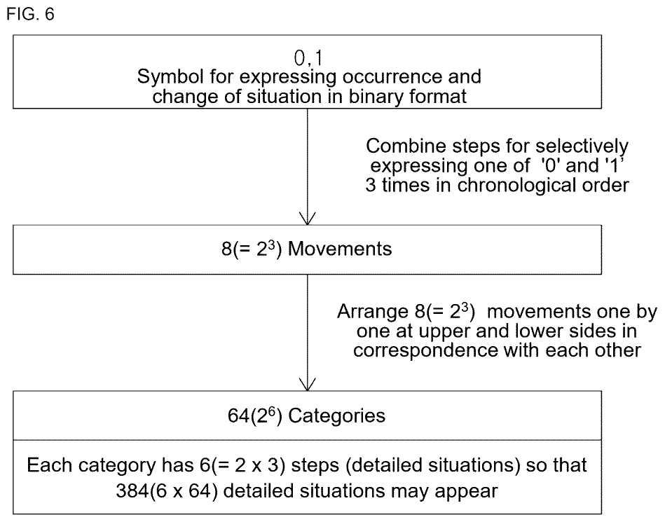

FIG. 6 is a diagram for explaining a summary of a process of generating 8 “movements” and 64 “categories” by using “0” and “1” used in the tool for situation determination and change predicting by applying the case of N=3 in FIG. 5.

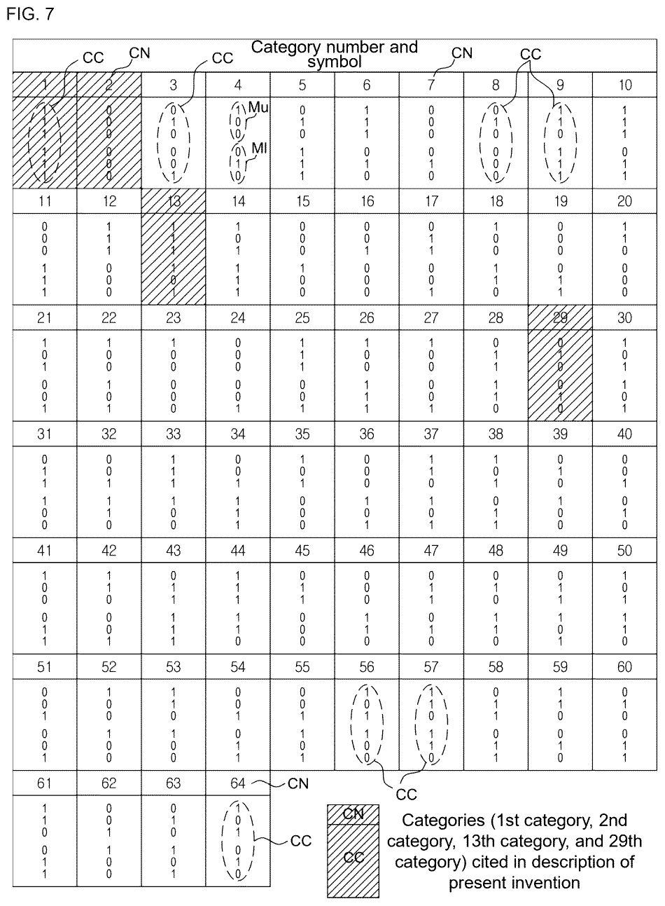

FIG. 7 is an exemplary diagram related to 64 “categories” used in the tool for situation determination and change prediction when N=3 in FIG. 5.

Referring to FIG. 7, category numbers CN are assigned to 64 categories generated by arranging 8 upper movements and 8 lower movements one by one at the upper and lower sides in correspondence with each other, according to the embodiment of the present invention, in which N=3. Each category number has a unique category code CC in which 6 elements of “0” or “1” are formed as a set.

The category code CC consists of three elements (“0” or “1”) related to the upper movement Mu and three elements related to the lower movement MI.

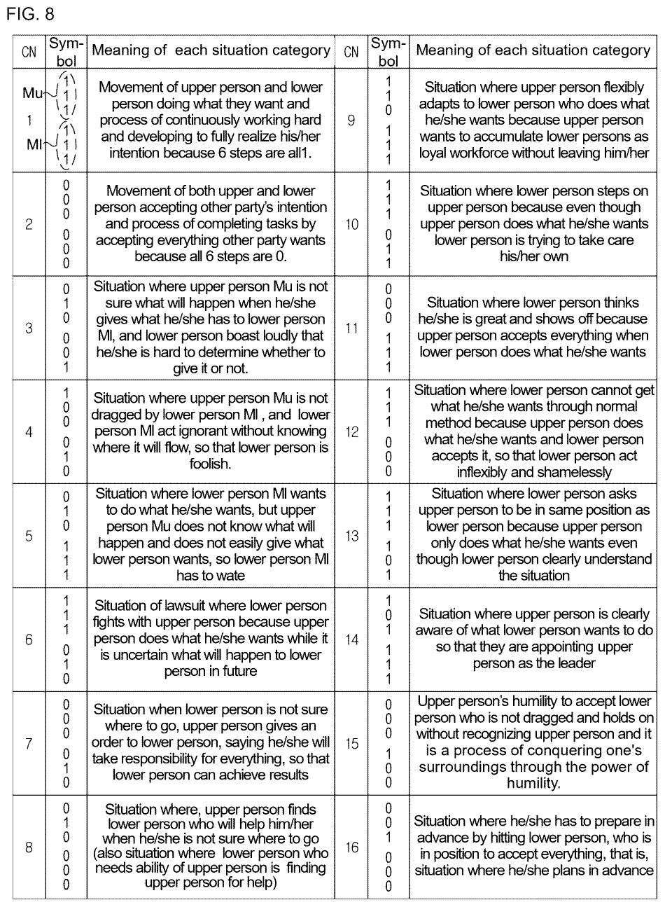

The category numbers CN assigned to each category are given in a progress sequence of situations, which will be described in detail later with reference to FIGS. 8 to 17.

FIGS. 8 to 11 are diagrams for explaining a meaning of each situation in 64 “categories” used in the tool for situation determination and change prediction when N=3.

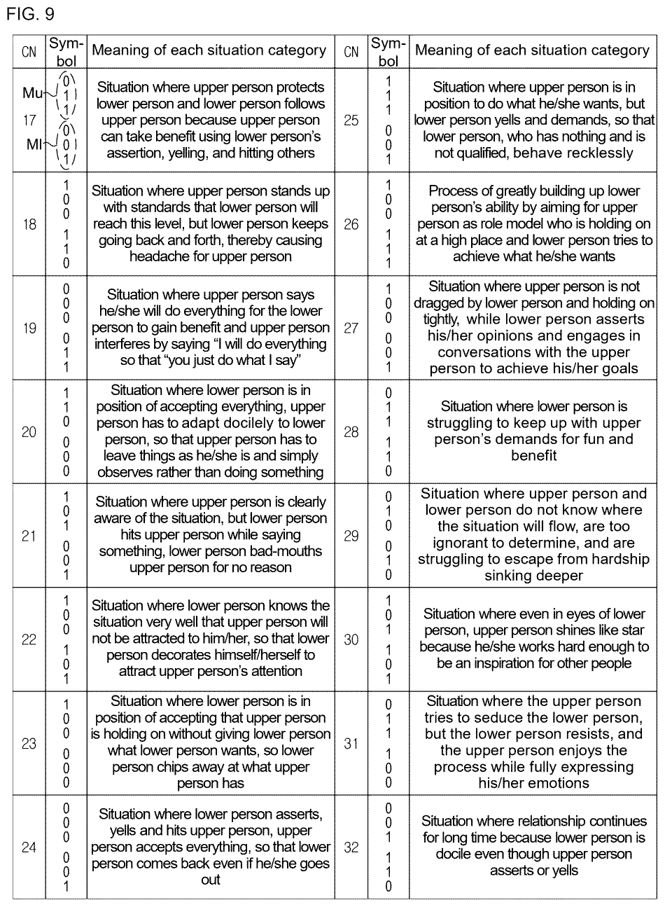

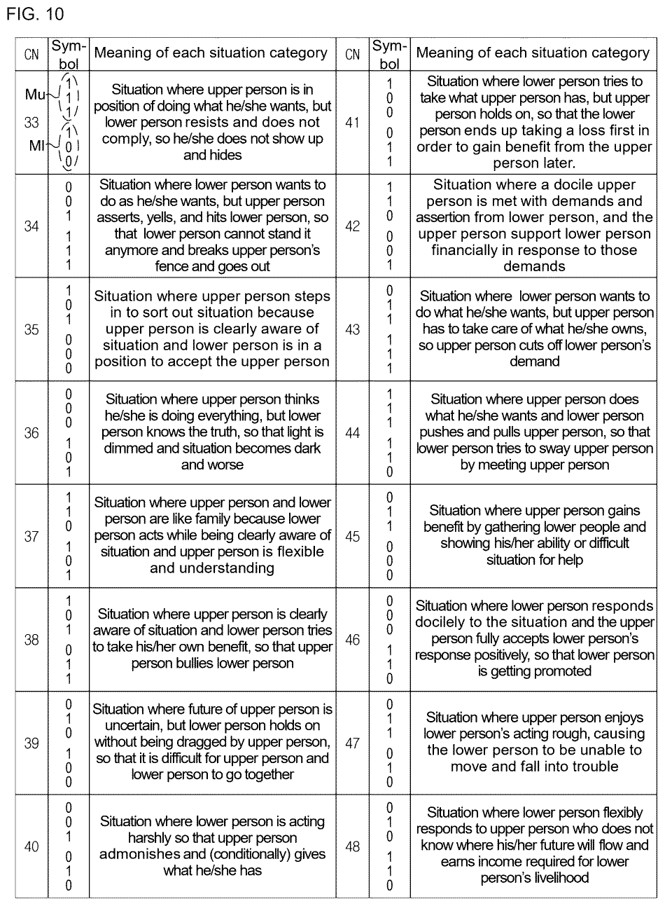

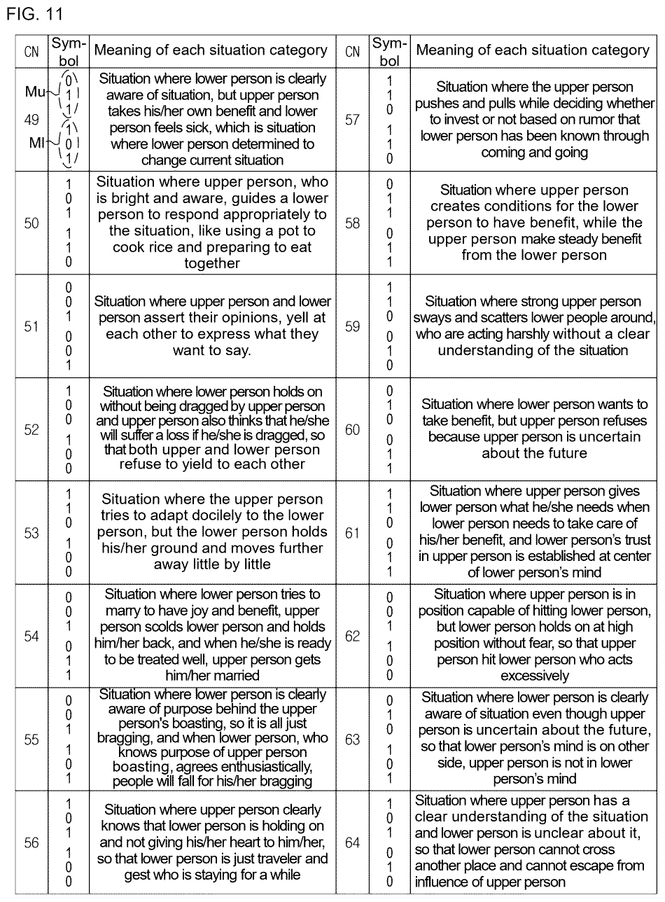

FIG. 8 is a diagram related to category numbers CN of 1 to 16, FIG. 9 is a diagram related to category numbers CN of 17 to 32, and FIG. 10 is a diagram related to category numbers CN of 33 to 48. In addition, FIG. 11 is a diagram related to category numbers CN of 49 to 64.

Referring to FIGS. 8 to 11, the meaning of the situation in each category is determined according to the characteristics of the upper movement and the characteristics of the lower movement corresponding to each other.

Referring to the category number N=1, for a specific example, “111” is a case where the lower movement has a characteristic of doing what he/she wants from the beginning to the end, and “111” is a case where the upper movement also has a characteristic of doing what he/she wants from the beginning to the end. Accordingly, the first category, that is, the symbol CC “111 111” in the category number CN=1 is “A situation of working hard to fully realize his/her own intention from the beginning to the end”.

Referring to the category number CN=4, as another specific example, “010” is a case where the lower movement has a characteristic of acting ignorant without knowing where he/she will flow like flowing water, and “001” is a case where the upper movement has a characteristic of holding on like a mountain. Accordingly, the category code CC “010 001” in the 4th category, that is, the category number CN=4 is “A situation where the upper person is not dragged by the lower person's intention, but is just holding on like a mountain, and the lower person acts ignorant without knowing where it will flow, that is, a situation where the lower person acts foolishly”.

Referring to the category number CN=13, for a specific example, “101” is a case where the lower movement has a characteristic of clearly understanding the situation, and “111” is a case where the upper movement has a characteristic of doing what he/she wants from the beginning to the end. Accordingly, the category code CC “101 111” of the 13th category, that is, the category number CN=13 is “A process of developing a situation where the lower person asks the upper person to be in the same position as the lower person because the upper person only does what he/she wants even though the lower person clearly understand the situation”.

Accordingly, in a case where situation determination and change prediction are required, when the category code CC from the upper and lower movements, which represents characteristics of upper and lower movements corresponding to each other, is known, we can grasp the category to which the occurred situation belongs.

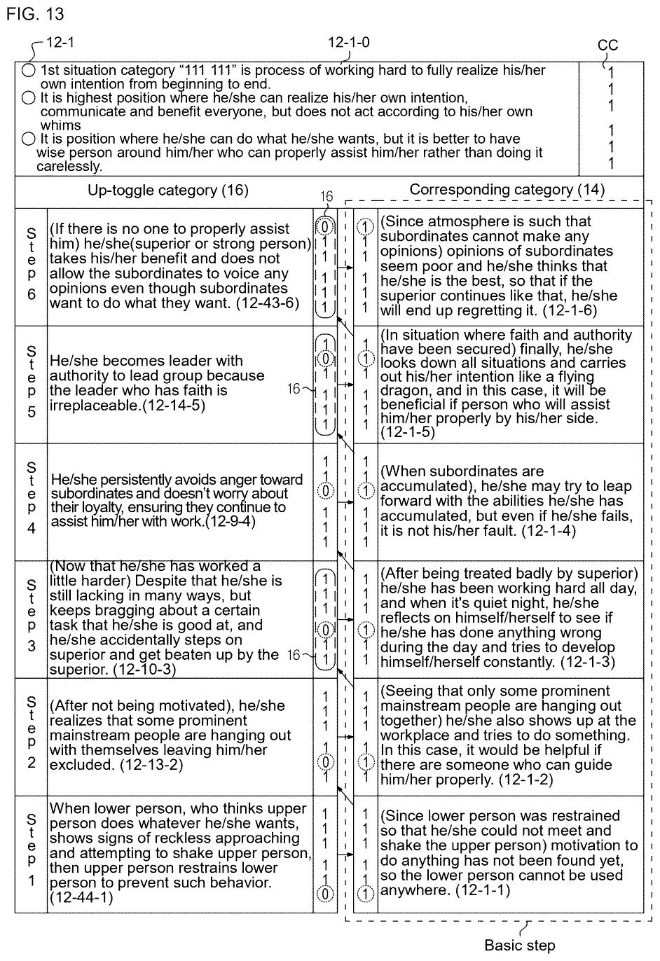

And, by confirming which specific step the detailed situation that has occurred corresponds to, we can predict in advance, using the up-toggle and level-toggle that will be described later with reference to FIGS. 13 to 17, how the detailed situation will change in the future.

In the present invention, numbers 1 to 2^{2N} attached to 2^{2N} categories are numbers representing a sequence of the categories, and the situation progressing in a sequence of numbers is defined as a “sequential procedure”.

In addition, in order for the situation to progress in the sequence of category numbers, 2N steps belonging to each category also need to be sequentially progressed, so that steps starting from the bottom and progressing up in ascending order may also be defined as the “sequential procedure”.

In the embodiment of the present invention, the “sequential procedure” is defined and described in ascending order.

Obviously, it is also possible to arrange 2N steps in descending order or to progress to the right in a horizontal direction.

However, it should be understood that it is obvious to those skilled in the art that when the movements are generated by combining the steps, the movements are generated in ascending order, and even when the relationship between the upper person (superior or strong person) and the lower person (inferior or weak person) is viewed, it is possible to place the upper person (superior or strong person) above and the lower person (inferior or weak person) below.

When the steps are combined N times to produce movements, a case of N=2 is also possible in the present invention. However, when N=2, there are only 4 (=2²) movements, only 16 (=24) categories, and only a total of 64 (=2⁴×4 step) detailed situations, so that there are some difficulties in representing changes in the world in detail.

When the steps are combined N times to produce movements, N=3 may be a preferred example in the present invention. This is because real-world changes may be represented in some detail but not too complicated.

That is, when N=3, the number of movements is 8 (=23), the number of categories reaches 64 (=2⁴), and the total number of detailed situations reaches 384 (=2⁶×6 step), which is suitable for people to learn and experience in their body and mind because it is not too complicated, and this may correspond to 8 trigrams, 64 hexagrams, and 384 lines in the Book of Changes.

When N=4 or more, there is an advantage of producing a more precise tool for determining situations and predicting changes. On the other hand, the number of categories and the total number of detailed situations are too large, thereby making it difficult to complete the situation category arrangement table in a short time with human intuition.

Therefore, when N=4 or more, the present invention may be implemented using artificial intelligence as a tool. That is, according to the present invention, the situation category arrangement table and the detailed situation progress list may be produced through a process of temporarily determining a category number by artificial intelligence inference, temporarily arranging an interpretation text in a step of each layer arranged in multi-layers, and performing verification by a person for a certain period of time.

Thereafter, through the process of applying and verifying various cases in the actual situation, the detailed situation progress list of the situation category arrangement table when N=4 or more may be modified and updated using an artificial intelligence-based tool to complete the detailed situation progress list.

Hereinafter, the embodiment according to the present invention will be described in more detail with reference to the accompanying drawings by taking the case of N=3, which is not too simple and not too complicated and is suitable for people to learn and experience, as an example.

FIGS. 7 and 8 to 11 show cases where N=3, in which numbers 1 to 64 attached to 64 categories represent the sequence of categories, and the situation that is progressed in the sequence of category numbers refers to the “sequential procedure”.

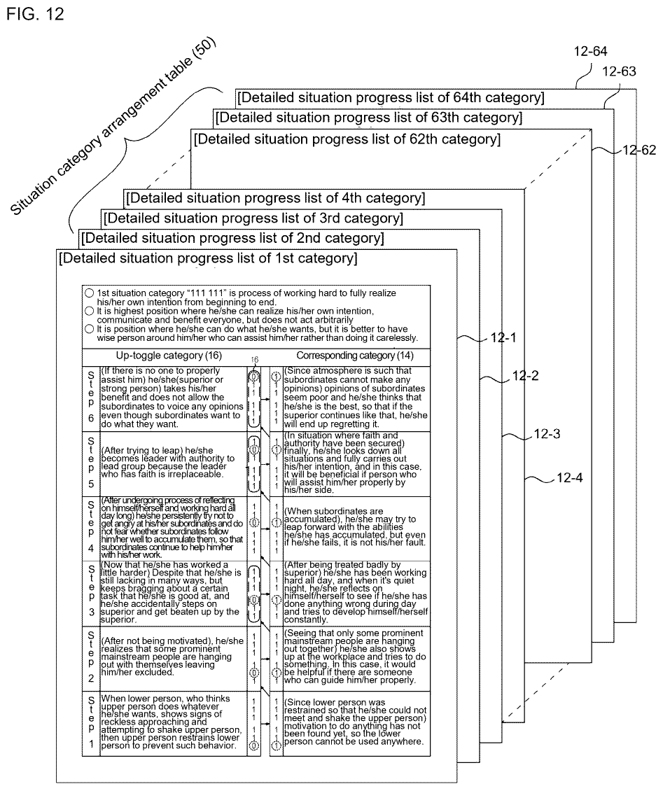

FIG. 12 is a situation category arrangement table 50 in which all categories are sequentially arranged in a sequence of numbers of 64 categories when N=3 according to the embodiment of the present invention.

FIGS. 13 to 17 are examples of detailed situation progress lists 12 for the case where N=3 according to the present invention.

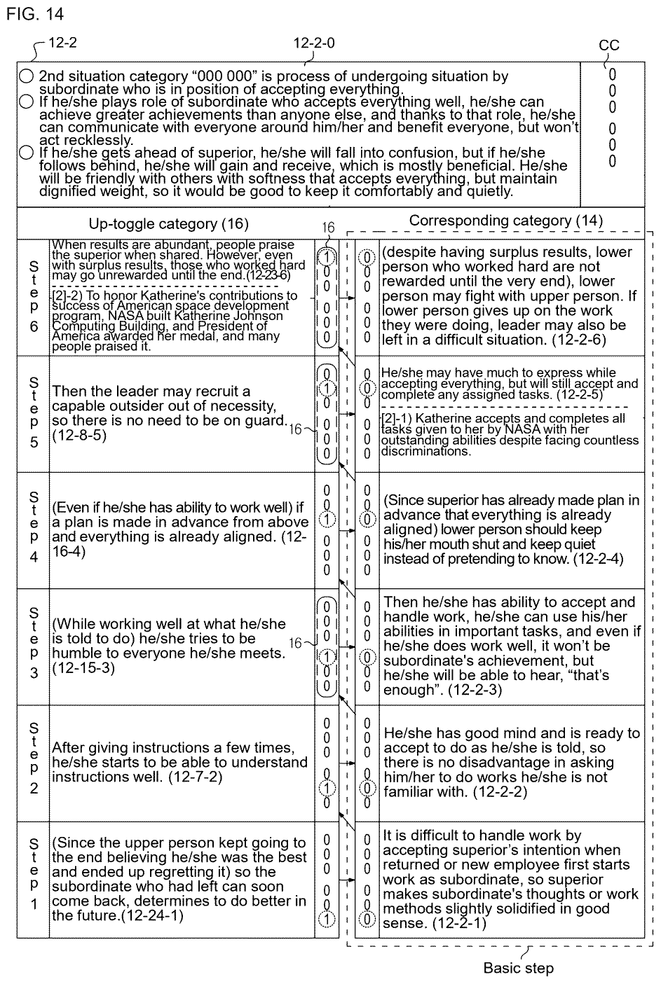

FIG. 13 is a detailed situation progress list 12-1 showing a sequential process of the 1st category, and FIG. 14 is a detailed situation progress list 12-2 showing a sequential process of the 2nd category.

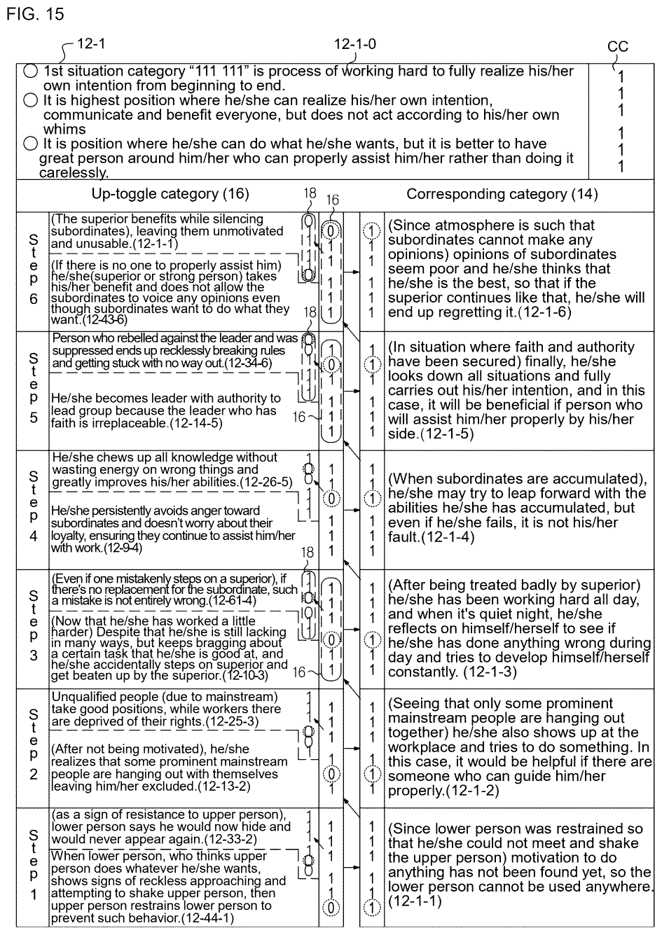

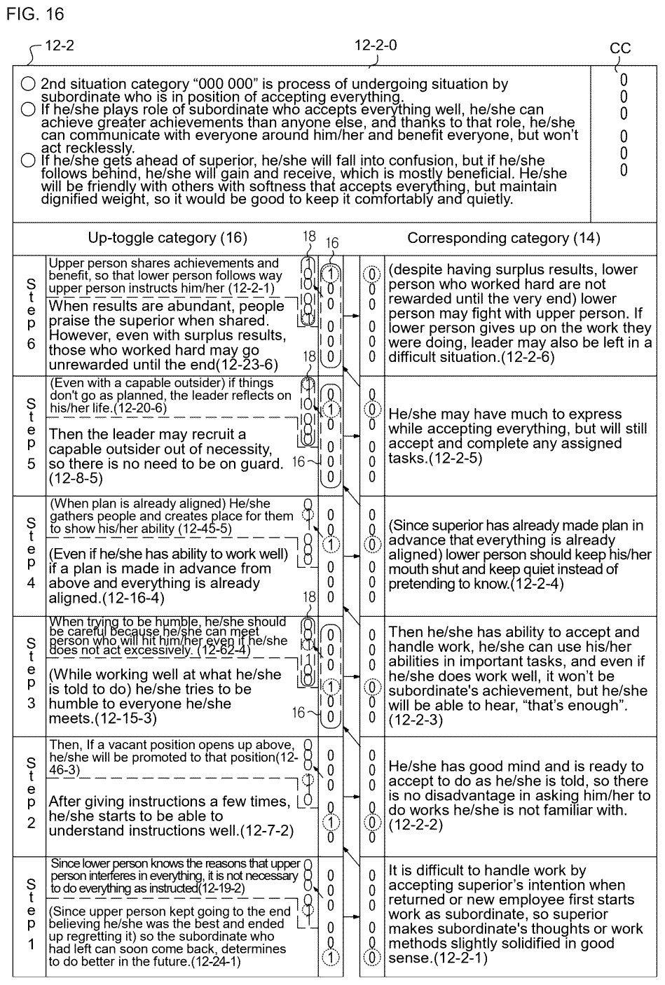

FIG. 15 is a detailed situation progress list 12-1 showing a non-sequential procedure development portion and the sequential process of the 1st category, and FIG. 16 is a detailed situation progress list 12-2 showing a non-sequential procedure development portion and the sequential process of the 2nd category.

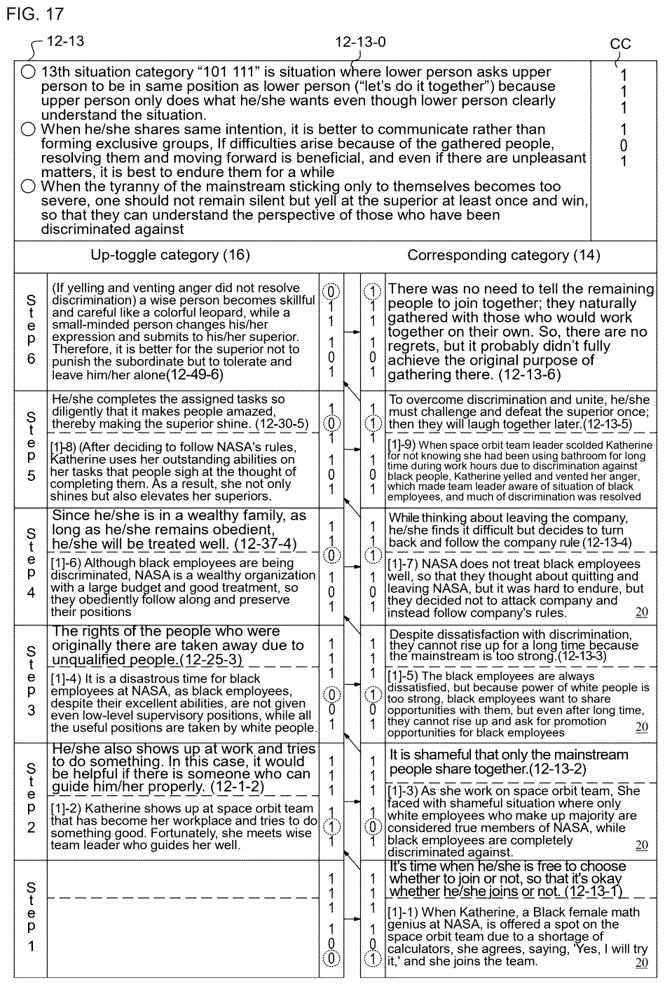

FIG. 17 is a detailed situation progress list 12-13 showing a case of a true story-based movie as an example of the sequential process of the 13th category.

In the present invention, in order for a user to easily understand the situation category arrangement table 50, as shown in FIGS. 13 to 17, more detailed situation progress lists 12-1, . . . , 12-64 for each category are configured.

In the detailed situation progress lists 12-1, . . . , 12-64 for each category, 6 steps belonging to the corresponding category are arranged in multi-layers from the first step at the bottom to the sixth step at the top according to a progress sequence of the detailed situation, and an interpretation text representing the meaning of the corresponding step is arranged in the step of each layer.

FIGS. 13 to 17 show a detailed situation progress list for the 1st category, the 2nd category, and the 13th category among 64 categories, and symbols and interpretation texts related to 6 steps constituting the corresponding category are expressed on the right side of the drawings.

Referring to FIG. 13, in the detailed situation progress list 12-1 for the 1st category, the upper movement Mu is composed of “1”, which has a characteristic of doing all three steps what he/she wants, and the lower movement MI is also composed of “1”, which has the characteristic of doing all three steps what he/she wants.

Accordingly, the detailed situation progress list 12-1 for the 1st category represents a process of doing what he/she wants from the beginning to the end, and more specifically, “a process of working hard and developing to fully realize his/her own intention”.

The detailed situation progress list 12-1 for the 1st category progresses through a six-step process, specifically from the first to the sixth steps.

The first step in the 1st category is a detailed situation just before fully entering the situation of still trying to express his/her own intention, and a detailed situation that means, “the motivation to do anything has not been found yet, so he/she cannot be used anywhere”.

From the second step to the fifth step in the 1st category is a process of developing in earnest to fulfill his/her own intention.

Therefore, when the step progresses from the first step in the 1st category to the second step in the 1st category, the step becomes a detailed situation that means, “He/she also shows up at the workplace and tries to do something. In this case, it would be helpful if there are someone who can guide him/her properly”.

When the step progresses from the second step in the 1st category to the third step in the 1st category, the step becomes a detailed situation that means, “He/she has been working hard all day, and when it's a quiet night, he/she reflects on himself/herself to see if he/she has done anything wrong during the day and try to develop himself/herself constantly”.

When the step is developed from the third step in the 1st category and progressed to the fourth step in the 1st category, the step becomes a detailed situation that means, “He/she may try to leap forward with the abilities he/she has accumulated, but there is no fault if he/she fails”.

When the step is developed from the fourth step in the 1st category and progressed to the fifth step in the 1st category, the step becomes a detailed situation that means, “Finally, he/she looks down all situations and freely carries out his/her intention like a flying dragon, and in this case, it will be beneficial if a person who will assist and properly help him/her by his/her side”.

When the step goes further from the fifth step in the 1st category and is progressed to the sixth step in the 1st category, the step becomes a detailed situation that means, “The opinions of subordinates seem poor and the superior thinks that he/she is the best, so that if the superior continues like that, he/she will end up regretting it”.

Through the progress to the sixth step, the situation of the 1st category ends, and the step progresses to the 2nd category, which is a sequential process.

When an event is continuously and sequentially progressed after the detailed situation where “The opinions of subordinates seem poor and he/she thinks that he/she is the best, so that if he/she continues like that, he/she will end up regretting it” in the last sixth step in the 1st category among 64 categories, the step is progressed to the first step in the 2nd category (see FIG. 14).

As shown in the detailed situation progress list 12-2 for the 2nd category of FIG. 14, the 2nd category is “0” for all 6 steps, which may be referred to as “a process experienced by the subordinate (inferior) who is in a position of accepting everything”.

Referring to FIG. 14, when the detailed situation is progressed to the first step in the 2nd category, the step becomes a detailed situation that means, “It is difficult to handle the work by accepting the superior's intention when the he/she who has returned or newly joined first starts the work as a subordinate, so the superior makes the subordinate's thoughts or work methods slightly solidified according to the principle in a good sense”.

Then, when the step is progressed to the second step in the 2nd category, the step becomes a detailed situation that means, “Since he/she has a good mind and is ready to accept, he/she does what he/she is told, so there is no harm in asking him/her to do works he/she is not familiar with”.

Then, when the step is progressed to the third step in the 2nd category, the step becomes a detailed situation that means, “Now, he/she has the ability to accept and handle the work, he/she can use his/her abilities in important tasks, and even if he/she does the work well, it won't be the subordinate's achievement, but he/she will be able to hear, “That's enough”.

Then, when the step is progressed to the fourth step in the 2nd category, the step becomes a detailed situation that means, “He/she should keep his/her mouth shut, and keep quiet instead of pretending to know, and then he/she will be free from troubles”.

Then, when the step is progressed to the fifth step in the 2nd category, the step becomes a detailed situation that means, “As he/she goes through the process of accepting everything, there are many things he/she wants to express to the superior, but he/she does not express them all and accepts and completes all tasks that is given to him/her from the superior so that his/her work may be done well”.

Then, when the step is progressed to the sixth step in the 2nd category, the step becomes a detailed situation that means, “He/she may enter into a nerve-wracking fight with the superior. If the subordinate gives up on the work he/she is doing, it may be a situation where the superior gets in trouble”.

As described above, the sequential process up to the 2nd category among 64 categories has been described by way of example. In this way, the “sequential” process is that events progress in the sequence of category numbers from the 1st category to the 64th category, and within each category, the events are carried out in stages according to the sequence of steps.

As previously described, 6 steps constituting each category among 64 categories represent the degree of progress of the following detailed situation according to the position of the step.

The first step of each category corresponds to a detailed situation immediately before the situation meant by the corresponding category progresses in earnest.

The second step to the fifth step correspond to the stage in which the situation meant by the corresponding category is progressed in earnest, and the fifth step corresponds to the detailed situation corresponding to the climax of the corresponding category.

In addition, the sixth step corresponds to a detailed situation immediately after the situation meant by the corresponding category ends.

For example, the first step in the 1st category is a detailed situation that means, “The motivation to do anything has not been found yet” so that it can be seen that he/she has not yet entered the situation where he/she wants to do, the fifth step means “He/she looks down all situations and freely carries out his/her intention like a flying dragon”, which certainly corresponds to the climax of the 1st category, and the sixth step means “Only do what he/she wants and ends up regretting it”, which is a step in which the situation of the 1st category ends.

To give one more example, the first step in the 2nd category is not yet in the step of handling tasks given from the upper person (superior or strong person), so the superior makes subordinate's thoughts or work methods slightly solidified in good sense, the 5th step is a climax step as he/she accepts and completes whatever task is assigned to him/her from the superior, and the sixth step is a situation where the role of accepting everything ends, so instead of accepting upper person he/she fights with the upper person (superior or strong person).

In addition, it has been defined that the change of the situation progresses in the order of the category numbers as progressing “sequentially”, and in an actual situation, in order for a certain situation to progress “sequentially”, the step is progressed to the next step in the corresponding category after undergoing an intermediate change process once as shown in the examples shown in FIGS. 13 to 17, rather than going directly from an arbitrary step in the corresponding category to the next step in the corresponding category.

Referring back to FIGS. 13 to 17, a process of going to the next step in the corresponding category 14 after undergoing the intermediate change process once to progress sequentially will be described in detail.

In each of the drawings of FIGS. 13 to 17, the right part in the drawing is steps directly belonging to the corresponding category 14, and the left part in the drawing is an intermediate connection ring connecting the steps directly belonging to the corresponding category, and the steps corresponding to the up-toggle category 16.

In order to sequentially change the situation, 0 and 1 of the adjacent upper step are toggled in the arbitrary step in the corresponding category 14, so that the arbitrary step is progressed to an up-toggle step and the situation is changed into the up-toggle category 16.

Referring to a specific example of FIG. 13, the step progresses from the first step [\textcircled{1}11 111] of the 1st category 14 to the up-toggle step [1\textcircled{0}1 111], in which 0 and 1 of the adjacent upper step (second step) [1\textcircled{1}1 111] are toggled, and the category is changed into the up-toggle category 16 (corresponding to the 13th category).

Thereafter, in order to sequentially change the situation, a level-toggle change in which 0 and 1 of the up-toggle step in the up-toggle category 16 are toggled forms an adjacent upper step in the corresponding category, thereby returning to the corresponding category 14.

Referring back to the specific example of FIG. 13, thereafter, in order to sequentially change the situation, the second step [1\textcircled{1}1 111] in the 1st category 14 is formed due to the level-toggle change in which 0 and 1 of the up-toggle step (second step) [1\textcircled{0}1 111] of the up-toggle category 16 (corresponding to the 13th category) are toggled, thereby returning to the 1st category 14.

As described above, it is summarized that the sequential process is progressed from the arbitrary step in the corresponding category to the adjacent upper step in the corresponding category by one-time level-toggle after one-time up-toggle, and the process is repeated so that the situation sequentially progresses to the last step in the corresponding category, and then progresses to the next number category from the corresponding category.

Now, the sequential process, in which a category is changed into another category by above-described up-toggle change and progresses to the next step in the corresponding category due to the level-toggle change, will be described by applying 6 steps of detailed situations for each category attached with interpretation text, together with reference to FIGS. 13 and 14.

As shown in FIG. 13, the first step [\textcircled{1}11 111] in the 1st category is a detailed situation that means, “(Since lower person was tied up so that he/she could not meet and shake the upper person) the motivation to do anything has not been found yet, so the lower person cannot be used anywhere”.

Then, when the step is progressed to the up-toggle step (second step) [1\textcircled{0}1 111] in the up-toggle category 16 (corresponding to the 13th category), the step is a detailed situation that means, “(After not being motivated), he/she realizes that some prominent mainstream people are hanging out with themselves leaving him/her excluded”. Then, when the step is level-toggled to progress to the second step in the 1st category, the step is a detailed situation that means, “(Seeing that only some prominent mainstream people are hanging out together) he/she also shows up at workplace and tries to do something. In this case, it would be helpful if there are someone who can guide him/her properly”.

Then, when the step is up-toggled to progress to the third step in the 10th category, the step is a detailed situation that means, “(Now that he/she has tried a little harder) he/she is still lacking in many ways, but keeps bragging at certain tasks that he/she is good, and he/she accidentally steps on the superior and get beaten up by the superior who is the strong person”. Then, when the step is level-toggled to progress to the third step in the 1st category, the step is a detailed situation that means, “(After being treated badly by the superior) he/she has been working hard all day, and when it's a quiet night, he/she reflects on himself/herself to see if he/she has done anything wrong during the day and tries to develop himself/herself constantly”.

As can be seen herein, it is foolish to step on the upper person because he/she doesn't know well, but if he/she is treated badly by the upper person after that behavior, a person who is treated badly has feeling after being treated badly by the superior, so that even if he/she works hard all day long, he/she can continuously improve himself/herself by reflecting on himself/herself, so that he/she can use bad things as motive power for his/her own development.

In addition, when a person who has learned and experienced situation determination and change prediction according to the present invention keeps an eye on the situation, even if the inferior acts foolishly, the person do not hastily judge someone as simply foolish even if a subordinate acts unwisely. the person can easily keep an eye on the progress of the development without concluding that the inferior is foolish, so the person can help not only those who act foolishly but also those around him.

This is because those who have learned about situation determination and change prediction may predict how the situation will progress in the future.

Then, when the step is up-toggled to progress to the fourth step in the 9th category, the step is a detailed situation that means, “(After undergoing process of reflecting on himself/herself and working hard all day long) he/she persistently try not to get angry at his/her subordinates and do not fear whether subordinates follow him/her well to accumulate subordinates, so that subordinates continue to help him/her with his/her work.” Then, when the step is level-toggled to progress to the fourth step in the 1st category, the step is a detailed situation that means, “(When subordinates are accumulated), he/she may try to leap forward with the abilities he/she has accumulated, but even if he/she fails, it is not fault.”

Then, the step is up-toggled to progress to the fifth step in the 14th category, the step is a detailed situation that means, “(After trying to leap) he/she becomes leader with authority to lead group because the leader who has faith is irreplaceable.”. Then, when the step is level-toggled to progress to the fifth step in the 1st category, the step is a detailed situation that means, “(In situation where faith and authority have been secured) finally, he/she looks down all situations and freely carries out his/her intention like a flying dragon, and in this case, it will be beneficial if a person who will assist him/her properly helps him/her by his/her side. “.

Then, the step is up-toggled to progress to the sixth step in the 43rd category, the step is a detailed situation that means, “(If there is no one to properly assist him/her when he/she is fully carrying out his/her own intention) the upper person (superior or strong person) takes his/her profit and does not allow the subordinates to voice any opinions even though the subordinates want to do what they want”. Then, the step is level-toggled to progress to the sixth step in the 1st category, the step is a detailed situation that means, (Since atmosphere is such that subordinates cannot make any opinions) the opinions of subordinates seem poor and the superior thinks that he/she is the best, so that if he/she continues like that, he/she will end up regretting it”.

In this case, the situation in the 1st category ends and is about to move on to the 2nd category, and regarding the process up to this point, a connection process of performing up-toggle is added in the middle, so that it can be seen that the description of the change in situation becomes more detailed and natural.

In the last sixth step in the 1st category, the opinions of subordinates seem poor and the superior thinks that he/she is the best, so that if he/she continues like that, he/she will end up regretting it.

When the situation is continuously and sequentially progressed from the sixth step in the 1st category so that the step is up-toggled to progress to the first step in the 24th category as shown in FIG. 14, the step is a detailed situation that means, “(Since the upper person kept going to the end believing he/she was the best and ended up regretting it himself/herself), the subordinate who had left can soon come back and determines to do better in the future.” Then, when the step is level-toggled to progress to the first step in the 2nd category, the step is a detailed situation that means, “It is difficult to handle work by accepting superior's intention when returned or new employee first starts work as subordinate, so superior makes subordinate's thoughts or work methods slightly solidified in good sense”.

Then, when the step is up-toggled to progress to the second step in the 7th category, the step is a detailed situation that means, “(Once he/she starts to get used to way of working) after giving instructions a few times, he/she starts to be able to understand instructions well”. Then, when the step is level-toggled to progress to the second step in the 2nd category, the step is a detailed situation that means, “(Once he/she is in state where he/she can accept instructions well) he/she has good mind and is broad-minded enough to do as he/she is told, so there is no disadvantage in asking him/her to do works he/she is not familiar with”.

Then, when the step is up-toggled to progress to the third step in the 15th category, the step is a detailed situation that means, “(While working well at what he/she is told to do) he/she tries to be humble to everyone”. Then, when the step is level-toggled to progress to the third step in the 2nd category, the step is a detailed situation that means, “(Even with humility) he/she has ability to accept and handle work, he/she can use his/her abilities in important tasks, and even if he/she does work well, it won't be subordinate's achievement, but he/she will be able to hear, “that's enough”.

Then, when the step is up-toggled to progress to the fourth step in the 16th category, the step is a detailed situation that means, “(Even if he/she has ability to work well) if a plan is made in advance from above and everything is already aligned”. Then, when the step is level-toggled to progress to the fourth step in the second category, the step is a detailed situation that means, (Since superior has already made plan in advance that everything is already aligned) lower person should keep his/her mouth shut and keep quiet instead of pretending to know”.

Then, when the step is up-toggled to progress to the fifth step in the 8th category, “(If he/she just quietly does as he/she is told) the leader may put effort into recruiting a capable outsider, but since the recruitment was done out of necessity, it is better not to be on guard”. In this case, when the step is level-toggled to progress to the fifth step in the 2nd category, “(Whether it is instructions from the recruited superior or the leader) there are many things he/she wants to express in process of accepting everything, but he/she will accept and complete whatever tasks are assigned to him/her from above”.

Then, when the step is up-toggled to progress to the sixth step in the 23rd category, the step is a detailed situation that means, “(Due to the achievement of the subordinate who fully accepted and completed the tasks assigned from above), when there is an abundance of results, people praise when the results are shared. however, there are cases where, despite having surplus results, those who worked hard are not rewarded until the very end”. Then, the step is level-toggled to progress to the sixth step in the 2nd category, the step is a detailed situation that means, “(despite having surplus results, lower person who worked hard are not rewarded until the very end), lower person fights with upper person. If lower person gives up on the work he/she was doing, the leader may also be left in a difficult situation.”

As described so far, it can be seen that the progress of the situation becomes much clearer as the detailed situation information of the intermediate process is additionally provided while undergoing the intermediate process of level-toggle once more after up-toggle.

Such a sequential change process of the detailed situation is provided in the detailed situation progress list 12 and implemented as a tool for situation determination and change prediction. It may also be implemented as a method or a system for providing a situation determination and change prediction service using this tool.

As shown in FIGS. 15 to 17, when a certain situation occurs, the situation is progressed in a sequence of the steps in the corresponding category, and when the situation of the corresponding category ends, the situation is sequentially progressed to the situation in the next number of category, but the situation may be progressed in a completely different situation about another category in the middle.

Progressing to the completely different situation about the different category, that is, changing to the completely different situation, is defined as a “non-sequential procedure” in the present invention.

In a case where the situation is non-sequentially progressed, the step is not level-toggled after the up-toggle, but is up-toggled (first up-toggle) and then up-toggled once more (second up-toggle), so that the situation is changed into a situation in the completely different category.

Referring to FIGS. 15 and 16 to describe the “non-sequential procedure” in more detail, the detailed situation progress lists 12-1 and 12-2 includes a non-sequential procedure development portion 18 in which in order for the situation to be non-sequentially changed in a state where the category is changed into another category due to progress to the up-toggle step described above, 0 and 1 of the adjacent upper step of the up-toggle step are toggled to form a second up-toggle step, thereby changing into a second up-toggle category.

In this case, the non-sequential procedure development portion 18 means the second up-toggle category.

When the detailed situation progress lists 12-1 and 12-2 include also the non-sequential procedure development portion 18, change prediction is possible because it can be seen that if changes occur when a certain situation occurs, the situation is progressed as one of a sequential change and a non-sequential change.

Even in actual reality, the step is not only sequentially progressed through the level-toggle after the up-toggle, and is progressed to a situation in the completely different category through the up-toggle once more after the up-toggle, that is, may be non-sequentially progressed in many cases.

To understand the non-sequential process, first, refer to the 44th category shown in the lower left of FIG. 15, which shows the sequential process of the 1st category and the non-sequential procedure development portion.

In FIG. 15, the first step in the 44th category 12-44 is a detailed situation that means, “When lower person, who thinks upper person does whatever he/she wants, shows signs of recklessly approaching and attempting to shake upper person, then upper person restrains lower person to prevent such behavior.”

In these detailed situations, the step progresses to one of two ways.

First, when the step is level-toggled from the first step in the 44th category 12-44 to progress to the first step in the 1st category 12-1, the step is progressed to a detailed situation that means, “the motivation to do anything has not been found yet, so the lower person cannot be used anywhere.”.

Second, the step may be up-toggled from the first step in the 44th category 12-44 to progress to the second step in the 33rd category 12-33, thereby progressing to a detailed situation that means, “(as a sign of resistance to upper person), lower person says he/she would now hide and would never appear again”

To exemplify the non-sequential process once more, refer again to the detailed situation progress list 12-1 in the 1st category shown in FIG. 15.

When the step is up-toggled from the first step 12-1-1 in the first category to progress to the second step 12-13-2 in the 13th category, the second step 12-13-2 of the 13th category is a detailed situation that means, “(After not being motivated), he/she realizes that some prominent mainstream people are hanging out with themselves leaving him/her excluded.”.

Even these detailed situations, the step progresses to one of two ways.

First, when the step is level-toggled from the second step 12-13-2 in the 13th category to progress to the second step 12-1-2 in the 1st category, the step is a detailed situation that means, “(Seeing that only some prominent mainstream people are hanging out together) he/she also shows up at the workplace and tries to do something. In this case, it would be helpful if there are someone who can guide him/her properly.”.

Second, the step is up-toggled from the second step 12-13-2 in the 13th category once more to progress to the third step 12-25-3 in the 25th category, the step may be a detailed situation that means “people who is not qualified (due to some prominent mainstream people) take a good position and people who work there are deprived of their rights”.

To exemplify the non-sequential process once again, refer again to the 1st category 12-1 shown in FIG. 15.

In the third step 12-10-3 in the 10th category, the detailed situation that means, “(Now that he/she has tried a little harder) he/she is still lacking in many ways, but keeps bragging that he/she is good, and he/she accidentally steps on the superior and get beaten up by the superior who is the strong person.” is reviewed.

Even in these detailed situations, the step also progresses to one of two ways.

First, the step is level-toggled from the third step 12-10-3 in the 10th category to progress to the third step in the 1st category, the step is a detailed situation that means, “(After being treated badly by the superior) he/she has been working hard all day, and he/she reflects on himself/herself at night to see if he/she has done anything wrong during the day and tries to develop himself/herself constantly”.

Second, when the step is up-toggled once more to progress to the fourth step 12-61-4 in the 61st category, the step may be a detailed situation that means, “(Even if lower person mistakenly steps on upper person), but if there is no one to replace the lower person, making such a mistake of stepping on the superior is not entirely wrong.”.

In this way, as shown in FIGS. 15 and 16, the step may be up-toggled to the changed category, and level-toggled then may be sequentially progressed to the next step in the corresponding category, but when the step may up-toggled once more to non-sequentially progress, not to sequentially progress, thereby changing into a situation in a completely different category.

FIG. 17 is an exemplary configuration diagram of a detailed situation progress list 12-13 showing the sequential process and actual application case of the 13th category among 64 categories according to the embodiment according to the present invention, in which N=3.

As shown in FIG. 17, since a detailed situation interpretation text and actual application case information according to the sequential change are provided in the detailed situation progress list 12-13 in the 13th category, an indirect experience for situation determination and change prediction may be provided to the user.

The tool or the method and system for providing a service of the present invention may be implemented to inform the principle of change, thereby enabling the user to determine a situation and predict changes by himself/herself without external help when a similar situation occurs to the user.

FIG. 17 is a case exemplary diagram in which the detailed situation progress list of the tool for situation determination and change prediction is applied to a true story-based movie according to the embodiment of the present invention.

The example of the case applied to FIG. 17 is an example that anyone can directly search and confirm through videos such as YouTube, and the movie “Hidden Figures” based on a true story about the performance of black female employees at NASA in the 1960s is taken as an example.

This movie shows the process of resolving discrimination as white people come to be together with black people through a certain opportunity in a situation where discrimination against black people in white society is severe, while undergoing detailed situations from the first step to the fifth step on the detailed situation progress list of the 13th category in FIG. 17.

In addition, apart from the situation in the 13th category of the detailed situation progress list in FIG. 17, the detailed situation progress list in FIG. 14 shows the process of accepting all assigned tasks in the fifth step, which is the climax in the 2nd category, and successfully completing all tasks to bring honor to their organization and country to which the black female employee belongs and obtain a proper honor.

First, to summarize the plot of the movie, in the 1960s, there was a social atmosphere in which white people did not get along with black people. The black female employees at NASA did not complain or give up on the organization even in the midst of the intense discrimination at the time. The black female employees at NASA are using their talents to help save the organization to which they belong and make the America great again. Thus, the movie shows a touching ending in which white leaders and white employees come to accept the black employees, and further, white society comes to a significant degree to be together with black people.

The movie was set in a time when the America was the most powerful country economically, but was always one step behind the Soviet Union in space development, which left not only NASA employees but also the Americans feeling defeated. One of the main reasons that Americans feel defeated is that every space flight test has failed due to the lack of computational power of the space orbit team.

The process of developing the detailed situations in the movie from the first step to the fifth step in the 13th category in the detailed situation progress list of FIG. 17 will be described as follows.

The detailed situation 1 in the movie ([1]-1 in FIG. 17) is,

“When Katherine, a black female employee at NASA who has shown a genius in mathematics since childhood, is offered, “The space orbit team is short on calculators, so would you like to try it out?”, the black heroine Katherine says, “Yes, I will try it” and decides to join the space orbit team according to the upper person's intentions”.

The detailed situation 1 in the movie corresponds to the detailed situation of the interpretation text “It is a time when he/she can freely choose whether to join or not, so it does not matter whether he/she join or not” in the detailed situation interpretation text of the first step 12-13-1 in the 13th category of FIG. 17.

Thereafter, the detailed situation 2 in the movie ([1]-2 in FIG. 17) is, “Katherine shows up at the space orbit team that has become her workplace and tries to do something well. In this case, it would be good if there was a great person by her side to lead her, and as it so happens, the white team leader of the space orbit team is a wise person, so that the heroine has met a wise person who can lead her”.

As the step is up-toggled from the first step in the 13th category to progress to the second step 12-1-2 in the 1st category, the detailed situation 2 in the movie corresponds to the detailed situation of the interpretation text “he/she also shows up at workplace and tries to do something. In this case, it would be helpful if there are someone who can guide him/her properly”.

Thereafter, the detailed situation 3 in the movie ([1]-3 in FIG. 17) is,

“As she works on the space orbit team, she faces the shameful situation where only the white employees, who make up the majority, are considered true members of NASA, while the black employees are completely discriminated against”.

As the step is level-toggled from the second step in the 1st category to progress to the second step 12-13-2 in the 13th category, the detailed situation 3 in the movie corresponds to the detailed situation of the interpretation text, “It is shameful that only the mainstream people share together”.

Thereafter, the detailed situation 4 in the movie ([1]-4 in FIG. 17) is, “It is a disastrous time for black employees at NASA, as black employees, despite their excellent abilities, are not given even low-level supervisory positions, while all the useful positions are taken by white people”.

As the step is up-toggled from the second step in the 13th category to progress to the third step 12-25-3 in the 25th category, the detailed situation 4 in the movie corresponds to the detailed situation of the interpretation text, “The rights of people who were originally there are deprived of their rights by unqualified people”.

Thereafter, the detailed situation 5 in the movie ([1]-5 in FIG. 17) is,

“The black employees are always dissatisfied, but because the power of white people is too strong, the black employees want to share opportunities with them, but even after a long time, they cannot rise up and ask for promotion opportunities for the black employees”.

As the step is level-toggled from the third step in the 25th category to progress to the third step 12-13-3 in the 13th category, the detailed situation 5 in the movie corresponds to the detailed situation of the interpretation text, “Even if they are unhappy about discrimination, they cannot rise up or do anything for a long time because the mainstream is too strong”.

Thereafter, the detailed situation 6 in the movie ([1]-6 in FIG. 17) is,

“Although they are being discriminated against, NASA is a wealthy company with a large budget and good treatment, so they are following along and maintaining their positions”.

As the step is up-toggled from the third step in the 13th category to progress to the fourth step 12-37-4 in the 37th category, the detailed situation 6 in the movie corresponds to the detailed situation of the interpretation text, “(Even if there is discrimination) since he/she is in a wealthy family, as long as he/she remains obedient, he/she will be treated well”.

Thereafter, the detailed situation 7 in the movie ([1]-7 in FIG. 17) is,

“NASA does not treat the black employees well, so that she thought about quitting and leaving NASA, However, despite the hardship, she chose to endure it, instead of confronting the company, she decided to follow the company's rules.”

As the step is level-toggled from the fourth step in the 37th category to progress to the fourth step 12-13-4 in the 13th category, the detailed situation 7 in the movie corresponds to the detailed situation of the interpretation text, “While Thinking about leaving the company, he/she finds it difficult but decides to turn back and follow the rules of the company”.

Thereafter, the detailed situation 8 in the movie ([1]-8 in FIG. 17) is,

“(After deciding to follow the company's rules) Katherine Johnson, the black heroine, uses her outstanding abilities to work so hard and sweats so much that people are amazed at how she completes her tasks, thereby contributing greatly to the American moon exploration program, making not only herself shine, but also those above her, including her team leader shine”.

As the step is up-toggled from the fourth step in the 13th category to progress to the fifth step 12-30-5 in the 30th category, the detailed situation 8 in the movie corresponds to the detailed situation of the interpretation text, “(After deciding to follow the company's rules) he/she completes the assigned tasks so diligently that it makes people amazed, thereby making the superior shine.”

Thereafter, the detailed situation 9 in the movie ([1]-9 in FIG. 17) is,

“When the tyranny of only the mainstream white people hanging out together became very severe, the heroine Katherine, was frequently absent for long periods each day, and the leader of the space orbit team scolded her for this”, then she yelled and vented her frustration, saying, “there are no bathrooms for black people near this building, so we have to go to the black bathroom that is 800 meters away to go to the bathroom, the coffee pot used by black people is considered dirty, so we have to use a separate one. We are not allowed to wear necklaces or accessories, and we are only paid a pittance but work like a dog day and night. So, I'm sorry, but I have to go to the bathroom that is far away several times a day”, and finally, they made a connection, and the leader of the space orbit team understood the position of the black employees for the first time, took the initiative and made sure that the black people could use the same nearby bathrooms as white people, and eliminated a lot of other discrimination”.

As the step is level-toggled from the fifth step in the 30th category to progress to the fifth step 12-13-5 in the 13th category, the detailed situation 9 in the movie corresponds to the detailed situation of the interpretation text, “To overcome discrimination and be together, he/she must shout at their superior and defeat him once; only then they will laugh together later” for reference, a more detailed interpretation is as follows. “In a time when the tyranny of only the mainstream white people has become so severe, in order for everyone to come to a mutual understanding, he/she must first shout loudly, prompting the other party to move towards a resolution, which will eventually lead to a situation where they can smile together. Simply staying quiet will not work; one must shout loudly at least once at the superior and win the confrontation for their hearts to connect. The ability to shout first for unity is possible when he/she stands at the center with righteousness, and by arguing and winning at least once through words, the superior will come to understand the position of those who have been discriminated against)

This corresponds exactly to that detailed situation in the interpretation text.

Fortunately, the situation ended well in the actual movie and no longer undergone the situation of the up-toggle.

Assuming that the space orbit team leader did not understand Katherine's position and the situation progressed again to the up-toggle stage, the situation would have progressed as follows:

“(Even if the space orbit team leader did not resolve this discrimination until the end, even though she yelled and cried out) a wise person would not attack the team leader immediately, but would be careful (because she yelled at the leader, who is the superior described above) as she turned skillful like a colorful leopard, and a small person changed his/her expression and was obedient to the superior, but it is better for the superior not to punish the person who vented his/her anger and just tolerate her”.

As the step is up-toggled from the fifth step in the 13th category to progress to the sixth step in the 49th category, the situation corresponds to the detailed situation of the interpretation text, “(Even if the discrimination was not resolved even though he/she yelled and cried out) a wise person would be careful as he/she turned skillful like a colorful leopard, and a small person would soon be obedient to the superior, so it is better for the superior not to punish the inferior, and to just tolerate and leave him/her alone”.

As described above, the true story-based movie “Hidden Figures” shows a process in which the heroine undergoes the detailed situations of various steps from the first step to the fifth step in the 13th category, and NASA works with black employees as well as white employees.

Meanwhile, the true story-based movie “Hidden Figures” shows, separately from the situation in the 13th category, the black heroine Katherine Johnson, a NASA employee and genius mathematician, who “accepts and completes all the tasks given to her by NASA with her outstanding abilities despite facing countless discriminations” in the fifth step, which is the climax of the 2nd category”.

Thereafter, as shown in FIG. 14, the detailed situation 1 ([2]-1 in FIG. 14) of a separate and different situation in the movie corresponds to the detailed situation, “(Whether it is instructions from the recruited superior or the leader) there are many things he/she wants to express in process of accepting everything, but he/she will accept and complete whatever tasks are assigned to him/her from above” of the fifth step in the 2nd category.

That is, from the perspective of the subordinate who accepts everything accepted and properly completed all tasks in the situation of the fifth step, which is the climax of the 2nd category.

Thus, when the step is up-toggled to progress to the sixth step in the 23rd category, and the detailed situation 2 ([2]-2 in FIG. 14) of a separate and different situation in the movie progresses to the detailed situation of the interpretation text,

(Due to the achievement of the subordinate who fully accepted and completed the tasks assigned from above), when there is an abundance of results, people praise when the results are shared. however, there are cases where, despite having surplus results, those who worked hard are not rewarded until the very end

NASA and the American government shared the achievements appropriately for the actual heroine's contributions.

That is, the movie shows a happy conclusion that everyone praises, with NASA and the President of the United States of America acknowledging NASA's development and her contribution to making the USA great again, and NASA building the Katherine Johnson Computer Building named after the heroine, and the President of America awarding the heroine a medal.

As described above with reference to FIGS. 17 and 14, in the situation of the 13th category, white society is made to be with black peoples (see FIG. 17), and at the same time, in the fifth step in the 2nd category, Katherine accepts and fulfills all the situations that NASA demands from Katherine, so that the America and its own organization, NASA, make great efforts to make the America great again (see FIG. 14).

As the step is up-toggled from the fifth step in the 2nd category to compensate for performance in the sixth step of the 23rd category, it can be seen from FIG. 14 that the situation completely different from the situation in the 13th category of FIG. 17 is operating together.

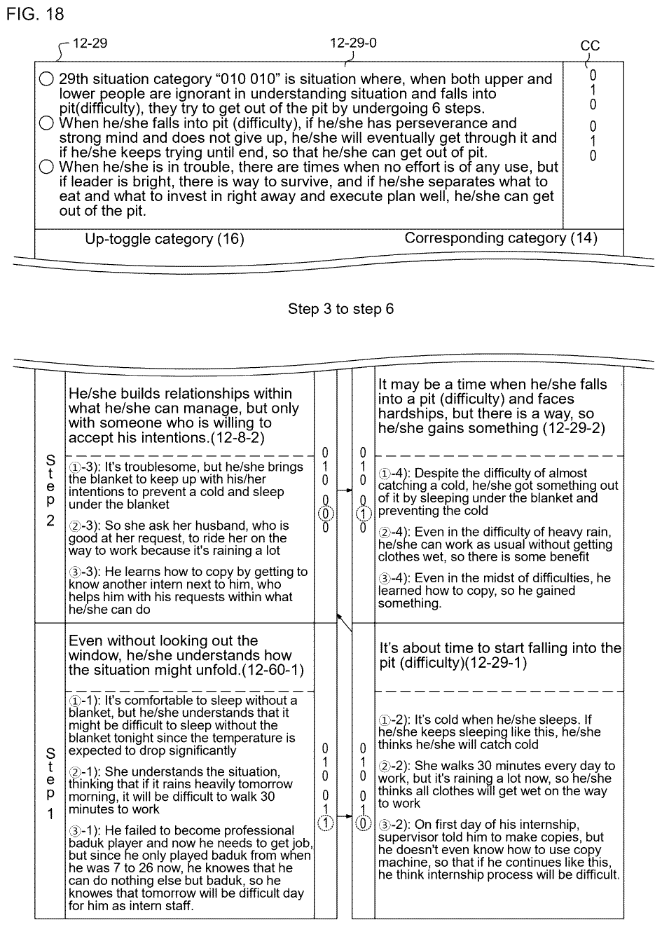

FIG. 18 is an exemplary diagram showing that the same detailed situation in the detailed situation progress list for situation determination and change prediction is reproduced by various cases when N=3 according to the embodiment of the present invention.

In FIG. 18, there are a total of three examples of various cases: the first case is \textcircled{1}-1) to \textcircled{1}-4); the second case is \textcircled{2}-1) to \textcircled{2}-4); and the third case is \textcircled{3}-1) to \textcircled{3}-4).

In addition, all three cases are situations about the 29th category (category code CC “010 010”), which means “the process of falling into a pit (difficulty) and getting out of the pit”.

All three cases start from the first step in the 60th category and are level-toggled to undergo the first step in the 29th category, and are up-toggled to undergo the second step in the 8th category, and then are level-toggled to progress to the second step in the 29th category.

The sequence of progressing the detailed situation of the first to third cases is as follows: first, the first step in the 60th category corresponds to the detail (interpretation text), “Even without looking out the window, he/she understands the situation to see if it will work or not”.

Thereafter, when the step is level-toggled, the first step in the 29th category corresponds to the detail(interpretation text), “he/she is slowly falling into the pit (difficulty)”.

Thereafter, when the step is up-toggled, the second step in the 8th category corresponds to the detail (interpretation text), “He/she makes relationships within the scope of what he/she can do, but only with someone who will accept his/her intentions”.

Thereafter, when the step is level-toggled, the second step in the 29th category corresponds to the detail (interpretation text), “It's a tough time when he/she falls into the pit (difficulty), but there is a way and there is something to be gained”.

To describe one of the above three cases in detail, in the first case, the first step in the 60th category is a detailed situation, “\textcircled{1}-1) It's comfortable to sleep without a blanket, but he/she understands that it might be difficult to sleep without the blanket tonight since the temperature is expected to drop significantly”, and thereafter, the step is level-toggled to progress to the first step in the 29th category, the step is a detailed situation, \textcircled{1}-2) “It's cold when he/she sleeps. If he/she keeps sleeping like this, he/she thinks he/she will catch a cold”.

Thereafter the step is progressed to the second step in the 8th category, the step is a detailed situation, \textcircled{1}-3) “It's troublesome, but he/she brings the blanket to keep up with his/her intentions to prevent a cold and sleep under the blanket”, and thereafter, when the situation is level-toggled so that the step is progressed to the second step in the 29th step, the is a detailed situation, \textcircled{1}-4) “Despite the difficulty of catching a cold, he/she got something out of it because he/she slept under the blanket and prevented the cold”.

To describe in more detail with one more example, in the second case, the first step in the 60th category is a detailed situation, \textcircled{2}-1) “It is said that it will rain tomorrow morning, but he/she knows that if it rains heavily, walking 30 minutes to work will be difficult.”, and thereafter, when the step is level-toggled to progress to the first step in the 29th category, the step is a detailed situation, \textcircled{2}-2) “He/she walks 30 minutes to work every day to get to work, but it's raining a lot now, so he/she think all clothes will get wet on the way”.

Thereafter, when the step is up-toggled to progress to the second step in the 8th category, that is a detailed situation, \textcircled{2}-3) “So she asks her husband, who is good at her request, to ride her on the way to work because it's raining a lot”. Thereafter, when the step is level-toggled to progress to the second step in the 29th category, the step is a detailed situation, \textcircled{2}-4) “Even in the difficult situation of heavy rain, he/she can work as usual without getting clothes well wet, so that there is some benefit”.

As described above with reference to FIG. 18, it can be seen that the same detailed situation in the detailed situation progress list may be reproduced in various cases.

Although all situations of 64 categories and 384 detailed situations may occur in reality according to the relationship between the level-toggle and the up-toggle in the present invention, there are patterns of the level-toggle and the up-toggle which have a high frequency of occurrence, and the probability of occurrence of each pattern may vary depending on changes in values over time.

“A person who utilizes the tool for situation determination and change prediction in the present invention can predict how a situation may change when a specific situation actually occurs.” Therefore, the tool for situation determination and change prediction of the present invention helps a person to avoid foolish behaviors, have a longer-term perspective, and perform wise behaviors.

The situation category arrangement table 50 of the present invention described in the specification of the present invention may be created in a table format that may be recognized with the naked eye and easily understood, but is not limited to a visual table. It should be understood that the situation category arrangement table 50 of the present invention may be expressed by voice, and may include a method of bringing its meaning into contact with the user's mind using brainwaves or other technologies, and various modifications and changes are possible.

Meanwhile, the present invention may further include a memo portion 20 (see FIG. 17) capable of recording one's own experience case in the detailed situation progress list 12 of the situation category arrangement table 50.

As shown in FIG. 17, the memo portion 20 is provided to enable the user to record his/her own experience case at a position of the multi-layered step as if the process of changing situations in the true story-based movie is recorded in a blank of the detailed situation progress list. The memo portion 20 may record the user's experience for the sequential and non-sequential changes of the user.

In addition, according to the present invention, the tool for situation determination and change prediction may include the detailed situation progress list for each category in the situation category arrangement table so that the user may edit the step details in a customized manner with reference to the basic interpretation text corresponding to the multi-layered steps.

The sequence of category numbers and elements “0” and “1” constituting steps of the detailed situation progress list 12 in each category are not subject to editing, and other details of categories and steps, for example, additional interpretation texts, application case information, and a memo portion, may be edited.

In the user-customized editing form, the tool user of the present invention may manually edit the content, or the server may modify and update the personalized detailed situation progress list based on the individual service content related to the terminal user, and may provide the modified and updated personalized detailed situation progress list to the user.

On the other hand, in constructing the tool for situation determination and change prediction, the present invention has a moving unit prepared for a case where it is necessary to move to a situation about the category changed in a state where the step progresses from an arbitrary step in the corresponding category of the detailed situation progress list to the up-toggle step.

That is, when it is necessary to move to the situation about the category changed in a state where the category is changed into another category, a detailed situation progress list moving mode execution unit capable of moving by a touch screen method of a user terminal such as a personal computer or a method such as a mouse click or a voice command is provided as the moving unit.

After executing the moving mode, the detailed situation progress list is changed into the up-toggle category or the second up-toggle category, and the corresponding step in the changed category may be designated and moved.

The situation category arrangement table 50 of the tool for situation determination and change prediction may be variously formed in a paper book form, an audio book form, an electronic document form including an e-book, an independently executable program form, a real-time provision form through a network server including the Internet, and the like, and may be configured in one or more complex forms thereof.

The situation category arrangement table 50 of the tool for situation determination and change prediction of the present invention may also be configured by applying other principle of changes (e.g., Hetu and Luoshu, five elements, etc.) including orientation and number arrangement.

The tool for situation determination and change prediction, which includes the situation category arrangement table 50 of the present invention, may be installed in a device for creating an extended reality (XR) including a device for creating augmented reality and a device for creating virtual reality, and a device for creating a metaverse environment.

The tool for situation determination and change prediction, which includes the situation category arrangement table 50 of the present invention, can be configured to be stored in a server equipped with artificial intelligence pre-learned with various information of the situation category arrangement table and actual application cases related to the situation determination and change prediction or dedicated artificial intelligence equipped user terminal, an electronic device equipped with a function of receiving a situation determination and change prediction service in real time, a robot, and an extended reality (XR) device.

In this case, the electronic device, the robot, and the extended reality (XR) device may include a support function unit which supports a user behavior recommendation service using artificial intelligence in preparation for a behavior situation of a user or an avatar of the user that deviates from a principle of the situation determination and change prediction.

The support function unit preferably has an information input device such as a camera or a microphone capable of confirming a situation of the user or the user avatar in real time.

In addition, the electronic device, the robot, and the extended reality (XR) device may include an autonomous behavior assistance service function unit for physically assisting an autonomous behavior of the user or the avatar of the user.

In addition, when the electronic device, robot, or extended reality device equipped with artificial intelligence includes an auxiliary service function unit, an autonomous behavior service program capable of controlling an avatar controller to be autonomously manipulated or the avatar to be autonomously operated is preferably installed such that an autonomous behavior service assisting the behavior of the user or the user avatar is possible.

When a device including the autonomous behavior assistance service function unit in which the autonomous behavior service program is installed is used to support the autonomous behavior service for the user, a user-customized wearable device capable of physically inducing the user's autonomous behavior is required.

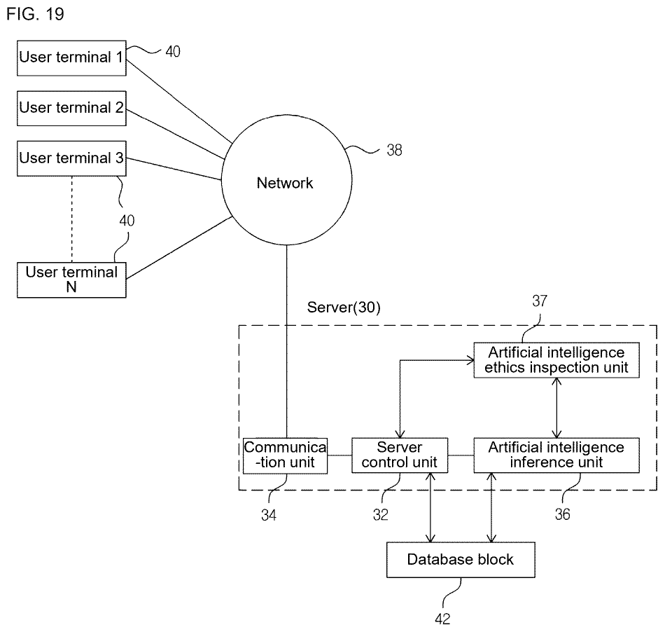

FIG. 19 is a configuration diagram of an online service system for providing a situation determination and change prediction service according to the embodiment of the present invention, in which a server 30 performing the situation determination and change prediction service is connected to a user terminal 40 through a network 38 and is also connected to a database block 42.

The server 30 is a concept including an artificial intelligence inference unit 36 and an artificial intelligence ethics inspection unit 37, and also including the database block 42, but in the example of the present invention described together with the drawings, the server 30 is classified as functional blocks.

The server 30 is a unit for confirming a user request received from the user terminal 40 through the network 38, performing the situation determination and change prediction service based on information of the situation category arrangement table 50 stored in the database block 42 and inference of the artificial intelligence inference unit 36, generating a service processing result, and providing the service processing result to the user terminal 40, and includes a server control unit 32, a communication unit 34, the artificial intelligence inference unit 36, and the artificial intelligence ethics inspection unit 37.

The user terminal 40 is a unit capable of interfacing with the user, and includes a personal computer (PC), a notebook computer, a mobile phone, a wearable device, a smart furniture, a robot device, and the like, but is not limited thereto, and may include various communication devices capable of accessing a server of a service operator through a wired/wireless communication network.

The artificial intelligence inference unit 36 confirms the user request of the user terminal 40 related to the situation determination and change prediction service in the server 30 using the situation category arrangement table 50 registered in the database block 42, and generates a service processing result related to situation determination and change prediction by artificial intelligence inference.

The artificial intelligence ethics inspection unit 37 is a functional unit that performs ethics inspection on the situation determination and change prediction service processing result performed by the artificial intelligence inference unit 36 before the server 30 provides the generated service processing result to the user terminal 40.

The database block 42 not only registers the situation category arrangement table 50 under the control of the server control unit 32 or the artificial intelligence inference unit 36, but also stores various information for processing the user request. For example, the database block 42 includes member information, authentication information, user analysis request information, situation category arrangement table update information, situation category arrangement table learning management information, level-based learning game information, case analysis information, and content information (collection and generation) for each field.

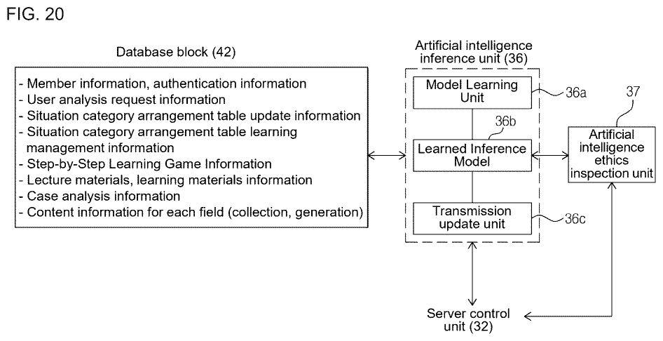

FIG. 20 is a detailed block configuration diagram related to the artificial intelligence inference unit 36, an artificial intelligence ethics inspection unit 37, and the database block 42 shown in FIG. 19.

Referring to FIG. 20, the artificial intelligence inference unit 36 includes a model learning unit 36a, a learned inference model 36b, and a transmission update unit 36c.

The model learning unit 36a continuously performs model learning using various defined information of the situation category arrangement table 50 in the database block 42 and various information from inside or outside.

More specifically, the model learning unit 36a interprets the category symbol consisting of “0” and “1” by using that “0”, which is a predefined basic element of the situation category arrangement table 50, means accepting the other party and that “1” means doing as his/her own way, under the control of the server control unit 32. In addition, a temporary interpretation text is assigned to each of 2N steps constituting each category, and the detailed situation progress list 12 of the situation category arrangement table 50 is registered and updated through learning on various case information. The model learning unit 36a mainly learns through a deep learning process through the artificial neural network so as to process unstructured data such as images, videos, sounds, voices, and texts.

The learned inference model 36b is a model generated by performing model learning of the model learning unit 36a. That is, the learned inference model 36b is a model in which the contents of the situation category arrangement table 50 and the detailed situation progress list 12 for situation determination and change prediction are optimized. The learned inference model 36b is used for a real-time service that responds to the user request through the user terminal 40.

The transmission update unit 36c is a unit for transmitting and updating data in the artificial intelligence inference unit 36.

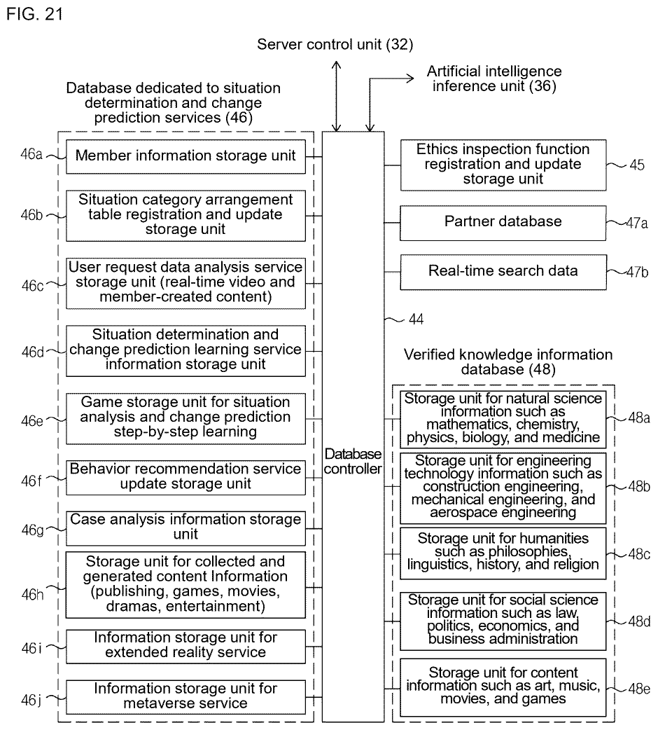

FIG. 21 shows a detailed block configuration of the database block 42 shown in FIGS. 19 and 20.

Referring to FIG. 21, the database block 42 for storing various information for providing the service of the present invention includes a dedicated database 46 dedicated to a situation determination and change prediction service, a verified knowledge information database 48, an ethics inspection function update database 45, and a database controller 44 for controlling various databases.

In constructing the database block 42 according to the present invention, the configuration of the dedicated database 46 for a situation determination and change prediction service is essential, and the configuration of the verified knowledge information database 48 is optional.

The situation category arrangement table 50 is registered and updated in the database 46 dedicated to a situation determination and change prediction service under the control of the server 30.

The situation category arrangement table 50 that is registered and updated in the database 46 dedicated to the situation determination and change prediction is a tool including: 0 and 1 for expressing occurrence and change of situations in a binary format; a step for sequentially selecting one of 0 and 1 to combine the same; 2^{N} movements (N is a natural number of 2 or more) generated by combining the step N times and vertically arranging the step in chronological order; and 2^{2N} categories (N is a natural number of 2 or more) generated by arranging the 2^{N} movements (N is a natural number of 2 or more) one by one at upper and lower sides in correspondence with each other, in which the 2^{2N} categories (N is a natural number of 2 or more) classify and define situations that occur according to correspondence of upper movement and lower movement, and 2N steps constituting each category classify and define the detailed situations within the category, and in which the tool includes a situation category arrangement table in which 2^{2N} categories (N is a natural number of 2 or more) are sequentially arranged with corresponding numbers in order to represent that the situations are sequentially progressed according to a sequence of category numbers, and represent that the detailed situations are progressed according to a sequence of vertical arrangement of the steps belonging to each category.

For the service using the situation category arrangement table 50, the database 46 dedicated to a situation determination and change prediction service includes a member information storage unit 46a, a situation category arrangement table registration and update storage unit 46b, a user request data analysis service storage unit 46c related to user request data such as videos or user-produced contents, a situation determination and change prediction learning service information storage unit 46d, a game storage unit 46e for step-by-step learning situation determination and change prediction, a behavior recommendation service update storage unit 46f, a case analysis information storage unit 46g, a collection and generation content information storage unit 46h (publication, game, movie, drama, and entertainment), an information storage unit 46i for an extended reality service, and an information storage unit 46j for a metaverse service.

In addition to the dedicated database, in order to secure the reliability of the situation determination and change prediction service, the verified knowledge information database 48 composed of verified data with little possibility of bias such as information contamination or ideology may be constructed.

The verified knowledge information database 48 includes a storage unit 48a for natural science information (such as mathematics, chemistry, physics, biology, and medicine), a storage unit 48b for engineering technology information (such as construction engineering, mechanical engineering, and aerospace engineering), a storage unit 48c for humanities (such as philosophies, linguistics, history, and religion), a storage unit 48d for social science information (such as law, politics, economics, and business administration), and a storage unit 48e for content information (such as art, music, movies, and games).

The verified knowledge information database 48 may be constructed by itself, may use a cloud data center, or may be supported by a database owned by external institutions, and may use real-time search data of a search engine such as Google, if necessary.

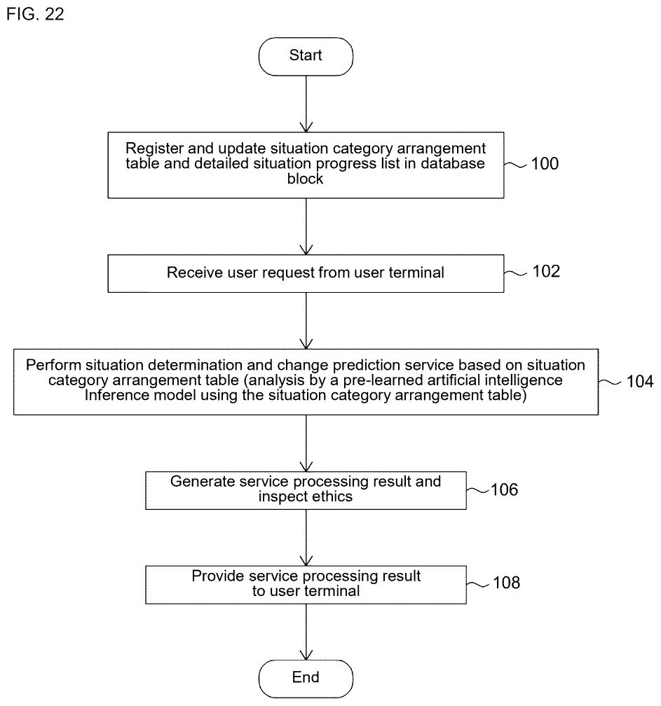

FIG. 22 is a schematic control flowchart of providing a situation determination and change prediction service according to the embodiment of the present invention.

A method for providing a service for situation determination and change prediction according to the embodiment of the present invention will be described in more detail with reference to FIGS. 19 to 22 together.

First, referring to FIGS. 19 and 22, the server 30 registers and updates the situation category arrangement table 50 in the database block 42 under the management of a server administrator, in which the situation category arrangement table 50 has 2^{2N} categories (N is a natural number of 2 or more) that are sequentially arranged with corresponding numbers in order to represent that the categories are sequentially developed according to a sequence of category numbers, and represent that the detailed situations are progressed according to a sequence of vertical arrangement of the steps belonging to each category (stage 100 of FIG. 22).

To describe the process of registering and updating the situation category arrangement table 50 in more detail, the server 30, under the control of the server control unit 32, interprets each category symbol composed of “0” and “1” by using that “0”, which is the most basic component of the situation category arrangement table 50, means accepting the other party, and “1” means doing as what he/she wants, and assigns an interpretation text to each step of 2N steps constituting each category, thereby preparing a detailed progress list of the situation category arrangement table 50.

Before the server 30 provides a customer service, the server control unit 32 performs a process of continuously updating the detailed situation progress list 12 of the situation category arrangement table 50 by reflecting a result of verifying the sequential and non-sequential relationships of the detailed situations through the up-toggle and the level toggle while undergoing a matching process with a video or the like, which may be obtained online, such as the Internet, with the help of the artificial intelligence inference unit 36.

The server control unit 32 registers and updates the situation category arrangement table 50 in the database block 42, but when the situation category arrangement table 50 is sufficiently updated, the customer service may be initiated with authentication of the server administrator.

After registering and updating the situation category arrangement table 50 in the server 30, the server 30 confirms the user request received from the user terminal 40 through the network 38 (stage 102 of FIG. 22).

Thereafter, the server control unit 30 performs the situation determination and change prediction service with the help of artificial intelligence based on the situation category arrangement table 50 of the database block 42 (stage 104 of FIG. 22). That is, under the control of the server control unit 32, the situation determination and change prediction are performed by the inference of the learned inference model 36b of the artificial intelligence inference unit 36.

Under the control of the server control unit 32, the artificial intelligence inference unit 36 performs the situation determination and change prediction service to generate a service processing result (stage 106 of FIG. 22).

In stage 106 of FIG. 22, if necessary, the server 30 also optionally performs an ethics inspection on the service processing result generated with the help of the artificial intelligence ethics inspection unit 37.

The reason why the service processing result undergoes the ethics inspection process before being provided to the user is that the analysis result provided to the user is useful to prevent the analysis results provided to the user from causing ethical problems. It is preferable that ethics inspection standards are applied with standards updated through various analyses, including comments, experiences, and social reactions.

The situation determination and change prediction service processing results generated by the server 30 may include a situation determination analysis result for a situation of the user, future change prediction, action recommendation content, and the like, and may be provided in the form of text, a voice file, or a video.

The situation determination and change prediction service processing result generated by the server 30 is provided to the user terminal 40 requesting the service through the network 38 (stage 108 of FIG. 22).

Accordingly, the user may receive the situation determination analysis result provided by the server 30 and the future change prediction and behavior recommendation content through his/her own user terminal 40.

In this case, a homepage service provided from the server 30 to the user of the user terminal 40 may include a chatting service, a learning service for situation determination and change prediction, an execution program providing service, a user-provided information analysis service, an actual situation analysis case providing service, a game service for situation determination and change prediction, a content providing service related to situation determination and change prediction, a behavior recommendation and autonomous behavior support service of the user or the user avatar, and the like, and the user may select a service desired by the user when accessing the homepage of the server 30 using the user terminal 40.

Among homepage services provided to the user, the chatting service may include consultations on user's concerns, learning consultations, requests for other services, or simple chatting services. Preferably, the chatting service is supported based on the pre-learned artificial intelligence, but if necessary, a consultation connection with a professional counselor is implemented.

Among the homepage services provided to the user, the user may select a game to play the game for situation determination and change prediction to improve situation determination and change prediction ability, and when the user wants to provide content related to situation determination and change prediction, the server 30 may provide the content using the generative artificial intelligence of the artificial intelligence inference unit 36.

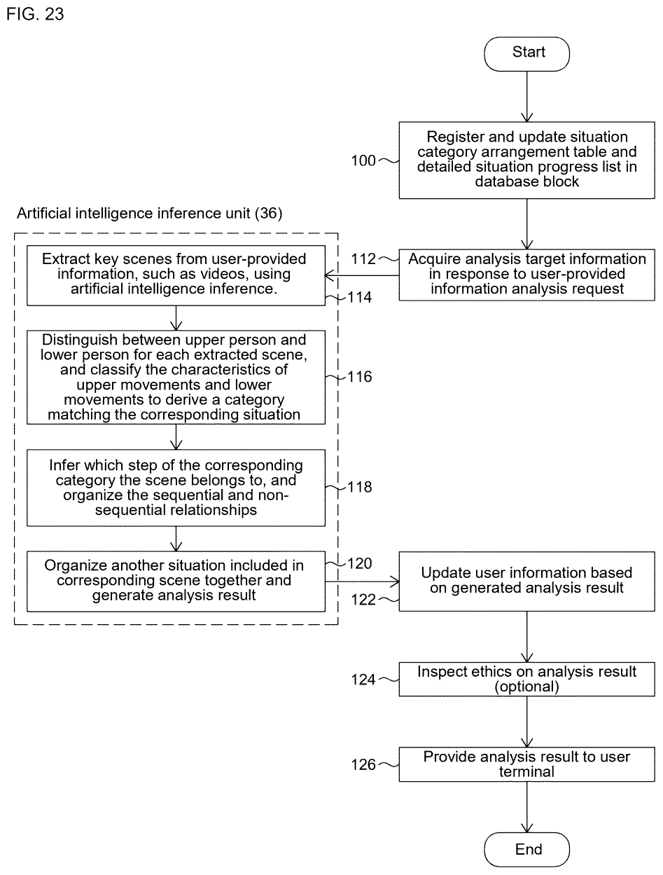

FIG. 23 is a control flowchart related to user-provided information analysis as a specific example of the situation determination and change prediction service according to the embodiment of the present invention.

As a specific example of the situation determination and change prediction service described in FIG. 23, the user-provided information analysis service is performed when the user request requests to analyze information such as an image, a video, a voice, a text, etc.

When the user request received from the user terminal 40 through the network 38 is the user-provided information analysis service, that is, when there is a user-provided information analysis request, the server 30 acquires analysis target information (stage 112 of FIG. 23).

The analysis target information acquired by the server 30 may include an image, sound information including voice and sound, text, an electronic document, a video file, an image generated in real time, a video, tactile information, olfactory information, and the like, and one or more thereof may be used.

Thereafter, the artificial intelligence inference unit 36 in the server 30 extracts key scenes from the analysis target information provided by the user, such as an image or a video, through artificial intelligence inference (stage 114 of FIG. 23).

For example, when the analysis target information is the sound information, the artificial intelligence inference unit 36 of the server 30 extracts voices by distinguishing the sound and the voices from the sound information, and distinguishes an individual speaker from the voices to store the same in the database block 42. In addition, if necessary, the speaker-specific speech is stored in the database block 42 as a text.

In addition, when the analysis target information is the video information, the artificial intelligence inference unit 36 separates the sound and the video from the video information, and matches the voice, other sounds, and key scenes of the video, to analyze the corresponding situations according to the progress sequence of the event.

After the key scene is extracted, the artificial intelligence inference unit 36 of the server 30 distinguishes an upper person (superior or strong person) and a lower person (inferior or weak person) according to the extracted scene, and classifies characteristics of the upper movement Mu and characteristics of the lower movement MI to derive the corresponding category (stage 116 of FIG. 23).

Thereafter, the artificial intelligence inference unit 36 of the server 30 infers the sequence of the step in a corresponding category that corresponds to a corresponding scene, and organizes sequential and non-sequential relationships (stage 118 of FIG. 23). As described with reference to FIG. 13 to FIG. 17, the organization of the sequential and non-sequential relationships refers to an organization of a case where the step is up-toggled from the arbitrary step of the situation category arrangement table 50 and level-toggled to be progressed sequentially, a case where the step is up-toggled and up-toggled once more to be progressed non-sequentially.

Thereafter, the artificial intelligence inference unit 36 of the server 30 organizes other situations included in the corresponding scene together, and generates an analysis result to update the user information based on the analysis result (stage 120 of FIG. 23).

The server 30 analyzes information such as an image, a video, a voice, a text, or the like possessed by itself by performing the procedures as in stages 114 to 120 of FIG. 20 based on the artificial intelligence pre-learned by the artificial intelligence inference unit 36, and updates the analysis result of the situation determination and the change prediction based on the user information in the database block 42 (stage 122 of FIG. 23).

In addition, the server 30 also optionally performs ethics inspection on the service processing result generated with the help of the artificial intelligence ethics inspection unit 37 (stage 124 of FIG. 23).

The server 30 provides the analysis result of situation determination and change prediction to the user terminal 40 requesting the service through the network 38 (stage 126 of FIG. 23).

In addition, the server 30 may provide the user of the user terminal 40 with a behavior recommendation service or an autonomous behavior service based on the situation determination and change prediction service.

Meanwhile, the server 30 for performing the situation determination and change prediction service according to the embodiment of the present invention may be constructed in a dedicated platform environment of the service provider, and may also be constructed in another platform environment that is previously constructed.

Moreover, the server 30 for performing the situation determination and change prediction service according to the embodiment of the present invention may be constructed in a dedicated metaverse platform environment of the service provider, and may also be constructed in another metaverse platform environment that is previously constructed.

When the server 30 is a dedicated platform, the user may create content desired by the user in the dedicated platform environment (or in the dedicated metaverse platform environment).

In addition, the metaverse platform environment constructed by the server 30 is implemented such that the behavior recommendation service or the avatar autonomous behavior service based on the situation determination and change prediction service of the present invention may be supported even while enjoying a game, visiting, doing business, going to a bank, or having a meeting using an avatar of the user.

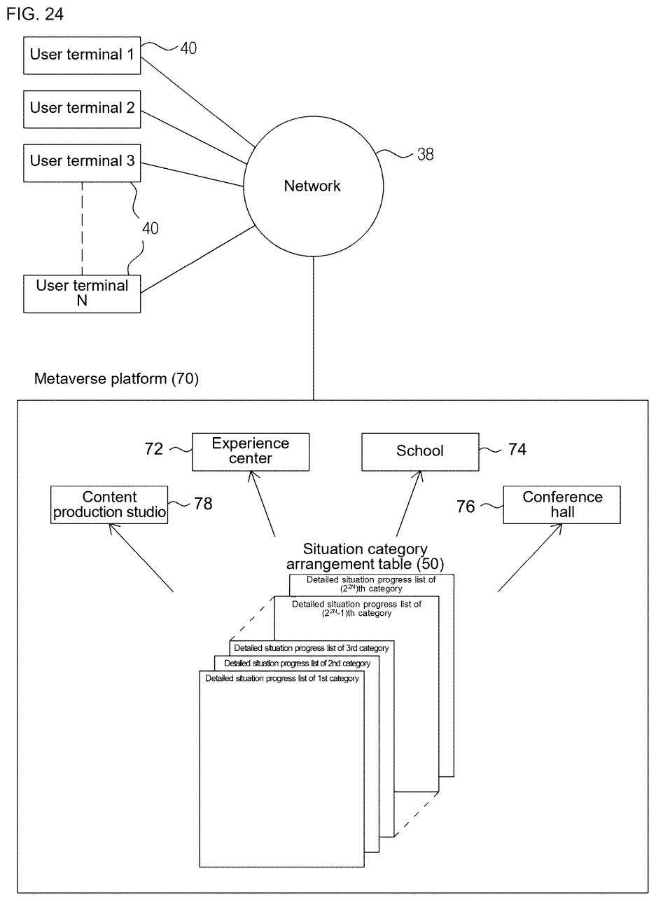

FIG. 24 is a configuration diagram of a service system for situation determination and change prediction, in which the server 30 is constructed in a metaverse platform environment according to the embodiment of the present invention.

The metaverse platform 70 is connected to the network 38 The metaverse platform 70 is provided with the situation category arrangement table 50 of the present invention as service units such as an experience center 72, a school 74, a conference hall 76, and a content production studio 78 for situation determination and change prediction.

Therefore, a user who visits the metaverse platform 70 using the user terminal 40 may receive regular services from the service units such as the experience center 72, the school 74, the conference hall 76, and the content production studio 78 based on the situation category arrangement table 50.

In the present invention, a dedicated server or a dedicated platform for situation determination and change prediction may be constructed, and in the case of the dedicated platform, it is preferable to create an environment in which the user may select an avatar behavior recommendation service or an avatar autonomous behavior service when the avatar of the user is generated.

In addition, in the present invention, as another method of providing a situation determination and change prediction service, the service may be installed in an electronic device that creates an extended reality environment and is independently provided.

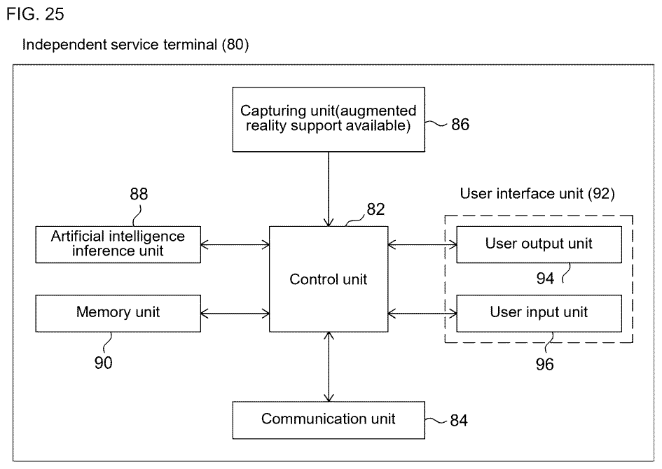

FIG. 25 is an exemplary block diagram of an independent service terminal 80 implementing a situation determination and change prediction service according to another embodiment of the present invention.

In another embodiment of the present invention, the independent service terminal 80 implements a situation determination and change prediction service to provide a service without an online connection such as the Internet.

The independent service terminal 80 according to another embodiment of the present invention includes a control unit 82, a communication unit 84, a capturing unit 86 for capturing a subject, an artificial intelligence inference unit 88, a memory unit 90, and a user interface unit 92 including a user output unit 94 and a user input unit 96.

The independent service terminal 80 according to another embodiment of the present invention installs the situation category arrangement table 50 of the present invention as an independent service type without supporting a dedicated service.

In FIG. 25, the control unit 82 and the communication unit 84 correspond to the server control unit 32 and the communication unit 34 of FIG. 19, respectively, the artificial intelligence inference unit 88 corresponds to the artificial intelligence inference unit 36 of FIG. 19, and the memory unit 90 corresponds to the database block 42 of FIG. 19. However, the configurations thereof are simplified in accordance with a terminal type.

The capturing unit 86 is a unit for acquiring image and video information by capturing a subject, and the user output unit 94 including a display and the user input unit 96 correspond to the user interface unit 92 for interface with the user.

It should be understood that the configuration of the capturing unit 86, the user output unit 94, and the user input unit 96 may be implemented as a device capable of functioning in an extended reality environment.

The independent service terminal 80 according to another embodiment of the present invention may provide an independent situation determination and change prediction service without supporting a dedicated server.

When there are image and video information using the capturing unit 86 and a user request using the user output unit 94 and the user input unit 96, the artificial intelligence inference unit 88 performs the situation determination and change prediction service based on the situation category arrangement table 50 of the memory unit 90 under the control of the control unit 82 to generate a service processing result. If necessary, the control unit 82 may also perform ethics inspection on the generated service processing result through an internal ethics inspection function unit.

The service processing result is provided to the user through the user interface unit such as the user output unit 92 of the independent service terminal 80. Then, the user may receive the situation determination and change prediction service through the independent service terminal 80 without an online connection such as the Internet.

The independent service terminal 80 according to another embodiment of the present invention may receive the situation determination and change prediction service without an online connection, but if necessary, the independent service terminal 80 may be connected to a dedicated server for situation determination and change prediction using the communication unit 84, thereby providing a real-time service to a user in an extended reality environment.

In the above description of the present invention, specific embodiments have been described, but various modifications may be implemented without departing from the scope of the present invention. Therefore, the scope of the present invention should not be determined by the described embodiments, but should be determined by the claims and their equivalents.

<Description of Reference Numerals>

| | |
|---|---|
| Mu: Upper movement | Ml: Lower movement |
| CC: Category code | CN: Category number |
| 50: Situation category arrangement table | 12: Detailed situation progress list |
| 12-1, 12-2: Detailed situation progress | |
| list of 1st and 2nd categories | |
| 12-13, 12-29: Detailed situation progress | |
| list of 13th and 29th categories | |
| 12-1-0, 12-2-0, 12-13-0: Situation interpretation | |
| text of 1st, 2nd, and 13th categories | |
| 12-1-1 to 6: Detailed situation interpretation | |
| text of first to sixth steps in 1st category | |
| 12-2-1 to 6: Detailed situation interpretation | |
| text of first to sixth steps in 2nd category | |
| 12-13-1 to 6: Detailed situation interpretation | |
| text of first to sixth steps in 13th category | |
| 12-29-0: Situation interpretation text of 29th | |
| category | |
| 12-29-1: Detailed situation interpretation text | |
| of first step in 29th category | |
| 12-29-2: Detailed situation interpretation text | |
| of second step in 29th category | |
| [1]-1 to 9: Detailed situations 1 to 9 of first | |
| [1] situation change case in a true story-based | |
| movie, focused on the 13th category | |
| [2]-1 to 2: Detailed situations 1 and 2 of second | |
| [2] situation change case in a true story-based | |
| movie, focused on the 2nd category | |
| \textcircled{1}-1 to 4: Detailed situations 1 to 4 of first | |
| (\textcircled{1}) situation change case in 29th category | |
| \textcircled{2}-1~4: Detailed situations 1 to 4 of second | |
| (\textcircled{2}) situation change case in 29th category | |
| \textcircled{3}-1 to 4: Detailed situations 1 to 4 of third | |
| (\textcircled{3}) situation change case in 29th category | |
| 14: Corresponding category | 16: Up-toggled category |
| 18: Non-sequential procedure development portion | |
| (=second up-toggled step changed into still another | |
| category) | |
| 20: Memo portion | Basic step: Corresponding |
| | category belonging step |
| 30: Server | 32: Server control unit |
| 34: Communication unit | 36: Artificial intelligence |
| | inference unit |
| 36a: Model learning unit | 36b: Learned inference model |
| 36c: Transmission update unit | 37: Artificial intelligence |
| | ethics inspection unit |
| 38: Network | 40: User terminal |
| 42: Database block | 44: Database controller |
| 45: Ethics inspection function registration and | |
| update storage unit | |
| 46: Database dedicated to situation determination | |
| and change prediction | |
| 48: Verified knowledge information database | |
| 70: Metaverse platform | |
| 72: Experience center | 74: School |
| 76: Conference hall | 78: Content production studio |
| 80: Terminal for independent service | 82: Control unit |
| 84: Communication unit | 86: Capturing unit |
| 88: Artificial intelligence inference unit | 90: Memory unit |
| 92: User interface unit | 94:: User output unit |
| 96: User input unit | |

1. A tool for situation determination and change prediction, the tool comprising:
0 and 1 for expressing occurrence and change of situations in a binary format;
a step for sequentially selecting one of 0 and 1 to combine the same;
2^{N} movements (N is a natural number of 2 or more) generated by combining the step N times and vertically arranging the step in chronological order; and
2^{2N} categories (N is a natural number of 2 or more) generated by arranging the 2^{N} movements (N is a natural number of 2 or more) one by one at upper and lower sides in correspondence with each other,
wherein the 2^{2N} categories (N is a natural number of 2 or more) classify and define situations that occur according to correspondence of upper movement and lower movement, and 2N steps constituting each category classify and define the detailed situations within the category, and
wherein the tool includes a situation category arrangement table in which 2^{2N} categories (N is a natural number of 2 or more) are sequentially arranged with corresponding numbers in order to represent that the situations are sequentially progressed according to a sequence of category numbers, and represent that the detailed situations are progressed according to a sequence of vertical arrangement of the steps belonging to each category.

2. A tool for situation determination and change prediction, the tool comprising:
0 and 1 for expressing occurrence and change of situations in a binary format;
a step for sequentially selecting one of 0 and 1 to combine the same;
8 movements generated by combining the step 3 times and vertically arranging the step in chronological order; and
64 categories generated by arranging the 8 movements one by one at upper and lower sides in correspondence with each other,
wherein the 64 categories classify and define situations that occur according to correspondence of upper movement and lower movement, and 6 steps constituting each category classify and define the detailed situations within the category, and
wherein the tool includes a situation category arrangement table in which 64 categories are sequentially arranged with corresponding numbers in order to represent that the situations are sequentially progressed according to a sequence of category numbers, and represent that the detailed situations are progressed according to a sequence of vertical arrangement of the steps belonging to each category.

3. The tool of claim 1, wherein a detailed situation progress list for each category is provided so as to create the situation category arrangement table, and
the detailed situation progress list for each category is configured
by arranging 2N steps, which belong to each category, in multi-layers from a first step at a bottom to a 2Nth step at a top according to a progress sequence of the detailed situation, and arranging an interpretation text representing a meaning of a corresponding step in the step of each layer, and
wherein a sequential procedure is repeated in which as the situation is sequentially changed, 0 and 1 of an adjacent upper step of an arbitrary step in a corresponding category are toggled so that the step is progressed to an up-toggle step and the corresponding category is changed into another category, and as the situation of an event is sequentially changed, an adjacent upper basic step is formed due to a change in a level toggle, in which 0 and 1 of the up-toggle step are toggled, thereby returning to the corresponding category.

4. The tool of claim 3, wherein the detailed situation progress list for each category further includes a non-sequential procedure development portion in which as the situation is non-sequentially changed in a state where the category is changed into another category due to progress to the up-toggle step, 0 and 1 of the adjacent upper step of the up-toggle step are toggled to form a second up-toggle step, thereby changing into still another category.

5. The tool of claim 4, wherein the detailed situation progress list is recorded with actual application case information according to a sequential change and a non-sequential change.

6. The tool of claim 3, wherein the detailed situation progress list further includes a memo portion which allows a user to record his/her experience case at a position of the corresponding step such that the user practices situation determination and change prediction.

7. The tool of claim 3, wherein the detailed situation progress list is editable in a user-customizable manner by referring to an interpretation text corresponding to steps that are arranged in multi-layers.

8. The tool of claim 3, wherein the situation category arrangement table includes a detailed situation progress list moving mode for moving to a situation about another category in a state where it is changed into another category since 0 and 1 of the adjacent upper step of an arbitrary step in the corresponding category of the detailed situation progress list are toggled so that the step is progressed to the up-toggle step.

9. The tool of claim 1, wherein the situation category arrangement table includes at least one of a paper book form, an audio book form, an electronic document form including an e-book, an independently executable program form, and a real-time provision form through a network server including an Internet.

10. The tool of claim 1, wherein the tool for situation determination and change prediction, which includes the situation category arrangement table, includes a device for creating extended reality (XR) including a device for creating augmented reality and a device for creating virtual reality, and a device for creating a metaverse environment.

11. The tool of claim 1, wherein the tool for situation determination and change prediction, which includes the situation category arrangement table, includes a user terminal having a server equipped with artificial intelligence that pre-learns various information of the situation category arrangement table and actual application cases related to the situation determination and change prediction or dedicated artificial intelligence, an electronic device equipped with a function of receiving a situation determination and change prediction service in real time, a robot, and an extended reality (XR) device.

12. The tool of claim 11, wherein the electronic device, the robot, and the extended reality (XR) device include a support function unit which supports a user behavior recommendation service using artificial intelligence in preparation for a behavior situation of a user or an avatar of the user that deviates from a principle of the situation determination and change prediction.

13. The tool of claim 11, wherein the electronic device, the robot, and the extended reality (XR) device include an autonomous behavior assistance service function unit for physically assisting an autonomous behavior of a user or an avatar of the user.

14. A method for providing a situation determination and change prediction service, the method comprising:
providing 0 and 1 for expressing occurrence and change of situations in a binary format;
providing a step for sequentially selecting one of 0 and 1 to combine the same;
providing 2^{N} movements (N is a natural number of 2 or more) generated by combining the step N times and vertically arranging the step in chronological order; and
providing 2^{2N} categories (N is a natural number of 2 or more) generated by arranging the 2^{N} movements (N is a natural number of 2 or more) one by one at upper and lower sides in correspondence with each other,
wherein the 2^{2N} categories (N is a natural number of 2 or more) classify and define situations that occur according to correspondence of upper movement and lower movement, and 2N steps constituting each category classify and define the detailed situations within the category, and
wherein the method comprises:
a process of registering and updating a situation category arrangement table in a database of a server, in which the situation category arrangement table has the 2^{2N} categories (N is a natural number of 2 or more) that are sequentially arranged with corresponding numbers in order to represent that the situations are sequentially progressed according to a sequence of category numbers, and represent that the detailed situations are progressed according to a sequence of vertical arrangement of the steps belonging to each category;
a process of confirming a user request received from a user terminal through a network, by the server;
a process of performing a situation determination and change prediction service based on the situation category arrangement table in response to the user request and generating a service processing result, by the server; and
a process of providing the generated processing result to the user terminal requesting the service through the network.

15. The method of claim 14, wherein the situation determination and change prediction service performed by the server includes a chatting service, a learning service, an execution program providing service, a user-provided information analysis service, an actual situation analysis case providing service, a game service, a content providing service, a user/user avatar behavior recommendation and autonomous behavior support service.

16. The method of claim 15, wherein user-provided information received from the user terminal is at least one of voice information, a text, an electronic document, a video file, an image generated in real time, a video, voice information, tactile information, and olfactory information.

17. The method of claim 15, wherein, when the user request received from the user terminal through the network is the user-provided information analysis service, the process of performing the situation determination and change prediction service based on the situation category arrangement table in response to the user request by the server includes:
a stage of acquiring analysis target information from the user terminal through the network;
a stage of extracting key scenes from information acquired by artificial intelligence inference according to situation progress;
a stage of dividing upper and lower sides for each extracted scene and classifying characteristics of an upper movement and characteristics of a lower movement to derive a corresponding category;
a stage of inferring a sequence of a step in a corresponding category that corresponds to a corresponding scene and organizing sequential and non-sequential relationships; and
a stage of organizing another situation included in the corresponding scene together, generating an analysis result, and updating user information based on the analysis result.

18. The method of claim 14, wherein, before providing the generated service processing result to the user terminal, an ethics inspection service using an artificial intelligence ethics inspection unit is performed under a control of the server.

19. A method for providing a situation determination and change prediction service, the method comprising:
providing 0 and 1 for expressing occurrence and change of situations in a binary format;
providing a step for sequentially selecting one of 0 and 1 to combine the same;
providing 2^{N} movements (N is a natural number of 2 or more) generated by combining the step N times and vertically arranging the step in chronological order; and
providing 2^{2N} categories (N is a natural number of 2 or more) generated by arranging the 2^{N} movements (N is a natural number of 2 or more) one by one at upper and lower sides in correspondence with each other,
wherein the 2^{2N} categories (N is a natural number of 2 or more) classify and define situations that occur according to correspondence of upper movement and lower movement, and 2N steps constituting each category classify and define the detailed situations within the category, and
wherein the method comprises:
a process of equipping a situation category arrangement table in at least one service unit of an experience center, a school, a conference hall, and a content production studio for situation determination and change prediction in a metaverse platform, in which the situation category arrangement table has the 2^{2N} categories (N is a natural number of 2 or more) that are sequentially arranged with corresponding numbers in order to represent that the situations are sequentially progressed according to a sequence of category numbers, and represent that the detailed situations are progressed according to a sequence of vertical arrangement of the steps belonging to each category; and
a process of receiving a service of the service unit based on the situation category arrangement table during a user's visit to the metaverse platform.

20. A method for providing a situation determination and change prediction service, the method comprising:
providing 0 and 1 for expressing occurrence and change of situations in a binary format;
providing a step for sequentially selecting one of 0 and 1 to combine the same;
providing 2^{N} movements (N is a natural number of 2 or more) generated by combining the step N times and vertically arranging the step in chronological order; and
providing 2^{2N} categories (N is a natural number of 2 or more) generated by arranging the 2^{N} movements (N is a natural number of 2 or more) one by one at upper and lower sides in correspondence with each other,
wherein the 2^{2N} categories (N is a natural number of 2 or more) classify and define situations that occur according to correspondence of upper movement and lower movement, and 2N steps constituting each category classify and define the detailed situations within the category, and
wherein the method comprises:
a process of installing a situation category arrangement table as an independent service type without supporting a dedicated support on a terminal that creates an extended reality (XR) environment, in which the situation category arrangement table has the 2^{2N} categories (N is a natural number of 2 or more) are sequentially arranged in order with corresponding numbers in order to represent that the situations are sequentially progressed according to a sequence of category numbers, and represent that the detailed situations are progressed according to a sequence of vertical arrangement of the steps belonging to each category; and
a process of receiving a service of a terminal service unit based on the situation category arrangement table, by a user who enters the extended reality (XR) environment created using the terminal.

21. A system for providing a situation determination and change prediction service, the system comprising:
0 and 1 for expressing occurrence and change of situations in a binary format;
a step for sequentially selecting one of 0 and 1 to combine the same;
2^{N} movements (N is a natural number of 2 or more) generated by combining the step N times and vertically arranging the step in chronological order; and
2^{2N} categories (N is a natural number of 2 or more) generated by arranging the 2^{N} movements (N is a natural number of 2 or more) one by one at upper and lower sides in correspondence with each other,
wherein the 2^{2N} categories (N is a natural number of 2 or more) classify and define situations that occur according to correspondence of upper movement and lower movement, and 2N steps constituting each category classify and define the detailed situations within the category, and
wherein the system comprises:
a database for storing a situation category arrangement table, in which the 2^{2N} categories (N is a natural number of 2 or more) are sequentially arranged with corresponding numbers in order to represent that the situations are sequentially progressed according to a sequence of category numbers, and represent that the detailed situations are progressed according to a sequence of vertical arrangement of the steps belonging to each category:
an artificial intelligence inference unit configured to infer a user request by artificial intelligence in relation to the situation determination and change prediction service using the situation category arrangement table of the database; and
a server configured to confirm the user request received from a user terminal through a network, to perform the situation determination and change prediction service based on information in the situation category arrangement table of the database and inference of the artificial intelligence inference unit, and to generate a service processing result, thereby providing the service processing result to the user terminal.

22. The system of claim 21, wherein the artificial intelligence inference unit includes an artificial intelligence training module configured to find change patterns of categories and steps and assign an interpretation text for each step by using characteristics of 0 and 1 and characteristics of movement, in which the steps are combined in chronological order and characteristics of each category, which is configured by arranging movements one by one at upper and lower sides in correspondence with each other, and characteristics according to a progress stage of the step belonging to each category, and configured to update the interpretation text through verification by a matching operation with an actual application case; and
a trained inference model configured to infer the user request based on a trained content of the artificial intelligence training module, and perform situation determination and change prediction.

23. The system of claim 21, wherein the database includes a database dedicated to the situation determination and change prediction service, and
the dedicated database includes a member information storage unit, a situation category arrangement table registration and update storage unit, a member request data analysis service storage unit, a situation determination and change prediction learning service storage unit, and a game storage unit for step-by-step learning a situation determination and change prediction.

24. A system for providing a situation determination and change prediction service, the system comprising:
0 and 1 for expressing occurrence and change of situations in a binary format;
a step for sequentially selecting one of 0 and 1 to combine the same;
2^{N} movements (N is a natural number of 2 or more) generated by combining the step N times and vertically arranging the step in chronological order; and
2^{2N} categories (N is a natural number of 2 or more) generated by arranging the 2^{N} movements (N is a natural number of 2 or more) one by one at upper and lower sides in correspondence with each other,
wherein 2^{2N} categories (N is a natural number of 2 or more) classify and define situations that occur according to correspondence of upper movement and lower movement, and 2N steps constituting each category classify and define the detailed situations within the category, and
wherein the system comprises:
a dedicated metaverse platform in which a situation category arrangement table is implemented in a service unit of each location in a metaverse, in which the situation category arrangement table has the 2^{2N} categories (N is a natural number of 2 or more) that are sequentially arranged with corresponding numbers in order to represent that the situations are sequentially progressed according to a sequence of category numbers, and represent that the detailed situations are progressed according to a sequence of vertical arrangement of the steps belonging to each category; and
a terminal connection unit configured to allow a user or a user avatar who visits the metaverse platform for situation determination and change prediction to receive a service of the service unit based on the situation category arrangement table.

25. The system of claim 24, wherein the dedicated metaverse platform is configured to support one or more of a behavior recommendation service and an autonomous behavior service for the user or the user avatar.
